(19) United States
(12) Patent Application Publication
(10) Pub. No.: US 2023/0372873 A1
(43) Pub. Date: Nov. 23, 2023

(54) ELECTROKINETIC DESALTING AND SALTING OF WATER-IN-OIL DROPLETS

(71) Applicant: Iowa State University Research Foundation, Inc., Ames, IA (US)

(72) Inventors: Aparna Krishnamurthy, Ames, IA (US); Robbyn K. Anand, Ames, IA (US)

(21) Appl. No.: 18/319,614

(22) Filed: May 18, 2023

Related U.S. Application Data
(60) Provisional application No. 63/368,953, filed on Jul. 20, 2022.
(60) Provisional application No. 63/364,933, filed on May 18, 2022.

(51) Int. Cl. B01D 61/46

(52) U.S. Cl. CPC B01D 61/46

(57) ABSTRACT

Microfluidic devices and methods that introduce ions into, and extract ions from, water-in-oil nanoliter scale droplets are disclosed. The droplets are in simultaneous contact with both an anion-permselective membrane and a cation-permselective membrane at opposing sides. When a voltage bias is applied across the system, anions and cations migrate across the respective permselective membranes and either into or out of the droplet.

### CROSS-REFERENCE TO RELATED APPLICATIONS

This application claims priority under 35 U.S.C. § 119 to provisional application Ser. No. 63/364,933, filed May 18, 2022, and provisional application Ser. No. 63/368,953, filed Jul. 20, 2022, both herein incorporated by reference in their entirety.

### GOVERNMENT RIGHTS

This invention was made with government support under National Science Foundation Grant No. CHE1849109. The government has certain rights in this invention.

### FIELD OF THE INVENTION

The present invention is related to extracting ions out of (desalting) or introducing ions into (salting) nanoliter-scale water-in-oil droplets. Specifically, water-in-oil (W/O) droplets are in simultaneous contact with both an anion-permselective membrane and a cation-permselective membrane at opposing sides of the droplet. For desalting a droplet, the cation-permselective membrane connects the droplet with the cathodic microchannel while the anion-permselective membrane connects the droplet with the anodic microchannel. A voltage bias is applied across the system, and cations within the droplet migrate out of the droplet, across the cation-selective membrane, and into the cathodic microchannel. At the same time, anions within the droplet migrate out of the droplet, across the anion-selective membrane and into the anodic microchannel. For salting a droplet, the electrode polarity is reversed such that the cation-permselective membrane connects the droplet with the anodic microchannel, and the anion-permselective membrane connects the droplet with the cathodic microchannel. Anions and cations migrate simultaneously across the respective parallel permselective membranes and into the droplet.

### BACKGROUND OF THE INVENTION

In-droplet ionic concentration distribution of a water-in-oil droplet can be electrokinetically manipulated by leveraging ion concentration polarization (“ICP”) within droplets. Concentration Enrichment, Separation, and Cation Exchange in Nano-liter-Scale Water-in-Oil Droplets, Kim, S et al., J. Am. Chem. Soc., 2020, 3196-3204. In this previous study a voltage bias was applied across a system containing water-in-oil droplets that were positioned over two cation-permselective membranes wetting the droplet. These permselective membranes connected the droplets which are in the main channel, to the cathodic and anodic auxiliary microchannels. With voltage application, ICP drives the formation of an ion depleted zone and an ion enriched zone within the droplet, enriching and separating charged species. Cation permselective membranes in such devices enable cation exchange within the droplet.

### BRIEF SUMMARY OF THE INVENTION

The present disclosure provides a microfluidic device comprising at least one fluidic main microchannel, wherein the one or more fluidic main microchannel is connected to at least one inlet and at least one outlet, wherein at least one water-in-oil droplet is infused through the at least one of the inlet(s), flows through at least a portion of the at least one main microchannel, and is withdrawn from at least one of the outlet(s); at least one cation-permselective membrane and at least one anion-permselective membrane, wherein a portion of each membrane extends into the main microchannel along a portion of the length of the main microchannel and a portion of each membrane extends outside of the main microchannel for electrical connection; and at least two auxiliary channels wherein a portion of the permselective membrane that extends outside of the main microchannel extends into a portion of an auxiliary channel wherein the auxiliary channel comprises an electrolyte solution, and wherein the cation-permselective membrane and anion-permselective membrane that extend into the same main microchannel do not extend into the same auxiliary channel, wherein the droplet is in simultaneous contact with a portion of the cation-permselective membrane and the anion-permselective membrane as the droplet flows through and/or is stationary in the main microchannel, and wherein a voltage bias is applied across the permselective membranes for droplet salting and/or desalting. In an embodiment, the cationic-permselective membrane and the anionic-permselective membrane contact the droplet at opposing sides of the droplet.

In an embodiment, the walls of at least one of the auxiliary channels comprises notches.

In an embodiment, the permselective membranes extend into the main microchannel for about the entire length of the main microchannel, for at least about half the length of the main microchannel, and/or for at least about 5% of the length of the main microchannel.

In an embodiment, one cation-permselective membrane and one anion-selective membrane extend into the main microchannel, and/or more than one anion-permselective membrane extend into a main microchannel.

In an embodiment, the auxiliary channels further comprise driving electrodes to apply the voltage bias across the permselective membranes.

In an embodiment, the device comprises more than one main microchannel in fluid connection with a singular inlet, more than one main microchannel in fluid connection with more than one inlet, more than one main microchannel in fluid connection with a singular outlet, and/or more than one main microchannel in fluid connection with more than one outlet.

In an embodiment, the device comprises more than one main microchannel, wherein at least one permselective membrane extends into a portion of more than one main microchannel, wherein the permselective membranes each extend into a unique auxiliary channel, and/or wherein at least two permselective membranes (of the same ion selectivity) extend into the same auxiliary channel. In an embodiment, the permselective membranes have a size and dimension such that the membranes run parallel on either side of the at least one main microchannel and extend into the main microchannel along the length of the main microchannel for a length necessary for salting and/or desalting to occur.

In an embodiment, the device further comprises uniform flow of the droplets from the at least one inlet to the at least one outlet. In an embodiment, the uniform flow is ensured by a pump at an inlet to infuse the droplets into the device, the uniform flow is ensured by a pump at an outlet to withdraw the droplets from the device, the uniform flow is ensured by a syringe attached to tubing at an inlet to infuse the droplets into the device, and/or the uniform flow is ensured by a syringe attached to tubing at an outlet to withdraw the droplets from the device. In an embodiment, the droplet flow rate is from about 0.0 μm/s to about 5000 μm/s.

In an embodiment, the at least one main microchannel has a length of about 1.0 mm to about 100 mm, a width of about 10 μm to about 1000 μm, and/or a height of about 10 μm to about 1000 μm. In an embodiment, the walls, ceiling, and/or floor of the main microchannel, and/or any auxiliary channel, comprise polydimethylsiloxane (“PDMS”), polymethylmethacrylate (“PMMA”), polystyrene, polycarbonate, cyclic olefin polymer, cyclic olefin copolymer, pressure sensitive adhesive tape, silicon, glass, resin of a 3D printer, polyethylene glycol, crosslinked polyethylene glycol diacrylate (“PEGDA”) resin, or combinations thereof.

In an embodiment, the volume of the droplets is from about 10 pL to about 50.0 nL. In an embodiment, the droplets comprise proteins, antigens, bioparticles, biomolecules, bacteria, virus, nucleic acids, enzymes, biological cells, DNA, RNA, aptamers, antibodies, peptides, peptide nucleic acids, morpholino oligonucleotides, receptors, other bioparticles, other nano/micro particles, or a combination thereof. In an embodiment, the droplets comprise blood, blood plasma, saliva, urine, sweat, tears, or any other such biofluid or any combination thereof. In an embodiment, the droplets comprise an electrolyte solution, phosphate buffer, and/or Tris buffer, and/or combinations thereof.

In an embodiment, the length of the permselective membranes is from about 1.0 mm to about 100 mm, the width of the permselective membranes is from about 50 μm to about 1000 μm, and/or the thickness of the permselective membranes is from about 1.0 μm to about 50 μm.

In an embodiment, the auxiliary microchannels have a length of about 2.0 mm to about 100 mm, a width of about 10 μm to about 1000 μm, and/or a height of about m to about 1000 μm.

In an embodiment, the electrolyte solution within the auxiliary channels comprises NaCl, KCl, Na₂SO₄, HCl, H₂SO₄, NaOH, KOH, NaNO₃, KNO₃, phosphate buffer, carbonate buffer, acetate buffer, borate buffer, Tris buffer, HEPES (4-(2-hydroxyethyl)-1-piperazineethanesulfonic acid), MOPS (3-(N-morpholino) propanesulfonic acid), TAE (Tris-acetate-EDTA), PIPES (piperazine-N,N′-bis(2-ethanesulfonic acid), tricine buffer, PBS (phosphate buffered saline) and/or combinations thereof.

In an embodiment, the outlet is connected to a droplet splitting device, and/or the outlet collects the droplets for further analysis and/or for further processing.

In an embodiment, the voltage applied to the permselective membranes is between about 0 and about 500 V.

In an embodiment, at least a portion the edge of at least one permselective membrane comprises notches and/or at least a portion of the edge of at least one permselective membrane is structured as notches, spikes, or a combination of any shape thereof.

In an embodiment, at least a portion of a permselective membrane is replaced with electrode material. In an embodiment, the electrode material comprises gold.

Provided herein is a method for extracting ions out of a droplet comprising flowing at least one water-in-oil droplet through at least one main microchannel of the microfluidic device of any one of the devices described herein; and applying a voltage bias across the device, wherein the auxiliary channel the cation-permselective membrane extends into is cathodic, wherein the auxiliary channel the anion-permselective membrane extends into is anodic, and extracting at least one ion out of the droplet.

In an embodiment, at least one cation within the droplet is extracted out of the droplet, across the cation-permselective membrane, and into the auxiliary channel. In an embodiment, at least one anion within the droplet is extracted out of the droplet, across the anion-selective membrane, and into the auxiliary channel. In an embodiment, the ions in the droplet are reduced by about 10%, about 20%, about 30%, about 40%, about 50%, about 60%, about 70%, about 80%, about 90%, or about 100%. In an embodiment, the pore size of the cation-permselective membrane and/or the pore size of the anion-selective membrane is such that large analytes are not extracted from the droplet. As used herein, an analyte includes, but is not limited to, proteins, antigens, antibodies, bioparticles, bacteria, virus, nucleic acids, or other biomolecules or combination thereof. As used herein, biomolecules comprise DNA, RNA, aptamers, antibodies, peptides, peptide nucleic acids, morpholino oligonucleotides, receptors, a small molecule that binds a cell-surface receptor such as folic acid, and the like, and combinations thereof.

Provided herein is a method for introducing ions into a droplet comprising flowing at least one water-in-oil droplet through at least one main microchannel of the microfluidic device of any one of the devices described herein; and applying a voltage bias across the device, wherein the auxiliary channel the cation-permselective membrane extends into is anodic, wherein the auxiliary channel the anion-permselective membrane extends into is cathodic, and introducing at least one ion into the droplet.

In an embodiment, at least one cation is extracted from the auxiliary channel, across the cation-permselective membrane, and into the droplet. In an embodiment, at least one anion is extracted from the auxiliary channel, across the anion-permselective membrane, and into the droplet. In an embodiment, the ions in the droplet are increased to a concentration about equal to the concentration of ions in the electrolyte solution or wherein the ions in the droplet are increased to a concentration of up to about ten times the concentration of ions in the electrolyte solution.

Provided herein is a method of introducing ions into a droplet and/or extracting ions from a droplet comprising flowing at least one water-in-oil droplet through at least one main microchannel of any device described herein; applying a voltage bias across the device for a period of time such that the auxiliary channel the cation-permselective membrane extends into is cathodic and the auxiliary channel the anion-permselective membrane extends into is anodic to extract at least one ion from the droplet; and/or applying a voltage bias across the device for a period of time such that the auxiliary channel the cation-permselective membrane extends into is anodic and the auxiliary channel the anion-permselective membrane extends into is cathodic to introduce at least one ion into the droplet.

In an embodiment, the method comprises applying the voltage bias to extract at least one ion from the droplet, and thereafter reversing the voltage bias to introduce at least one ion into the droplet as the droplet flows through the main microchannel and/or applying voltage bias to introduce at least one ion into the droplet, and thereafter reversing the voltage bias to extract at least one ion from the droplet as the droplet flows through the main microchannel. In an embodiment, the method comprises reversing the voltage bias at least one time to alternate introducing ions into the droplet and extracting ions from the droplet as the droplet flows through the main microchannel. In an embodiment, the method comprises reversing the voltage bias from one to 100 times as the droplet flows through the main microchannel.

In an embodiment of the method, the pore size of the cation-permselective membrane and/or the pore size of the anion-selective membrane is such that large microparticles are not extracted from the droplet. In an embodiment, the pore size of the cation-permselective membrane and/or the pore size of the anion-selective membrane is such that large analytes are not extracted from the droplet. As used herein, an analyte includes, but is not limited to, proteins, microparticles, and bioparticles.

Provided herein is a microfluidic device comprising at least one fluidic main microchannel, wherein the one or more fluidic main microchannel is connected to at least one inlet and at least one outlet, wherein at least one water-in-oil droplet is infused through the at least one of the inlet(s), flows through at least a portion of the at least one main microchannel, and is withdrawn from at least one of the outlet(s); at least two permselective membranes comprising notches, wherein a portion of each membrane extends into the main microchannel along a portion of the length of the main microchannel and a portion of each membrane extends outside of the main microchannel for electrical connection; and at least two auxiliary channels wherein a portion of the permselective membrane that extends outside of the main microchannel extends into a portion of an auxiliary channel wherein the auxiliary channel comprises an electrolyte solution, and wherein the at least two permselective membranes that extend into the same main microchannel do not extend into the same auxiliary channel, wherein the droplet is in simultaneous contact with both permselective membranes as the droplet flows through and/or is stationary in the main microchannel, and wherein a voltage bias is applied across the permselective membranes for monodirectional or unified salting and/or desalting. In an embodiment, the at least two permselective membranes comprise cation-permselective membranes. In an embodiment, the at least two permselective membranes comprise anion-selective membranes. Provided herein is a method of introducing ions into a droplet and/or extracting ions from a droplet comprising flowing at least one water-in-oil droplet through at least one main microchannel of the device applying a voltage bias across the device for a period of time to extract at least one ion from the droplet and introduce at least one ion into the droplet. In an embodiment, the extraction and introduction of ions is monodirectional. In an embodiment, the notches provide defined sites for introducing and extracting the ions. Provided herein is a method of geometrical confinement of at least one ion enrichment zone and/or at least one ion depletion zone within a droplet comprising flowing at least one water-in-oil droplet through at least one main microchannel of the device; and applying a voltage bias across the device for a period of time to geometrically confine at least one ion enrichment zone and/or at least one ion depletion zone within the droplet. In an embodiment, the notches provide higher surface area for electromechanical reactions inside the droplet.

Provided herein is a microfluidic device comprising at least one fluidic main microchannel, wherein the one or more fluidic main microchannel is connected to at least one inlet and at least one outlet, wherein at least one water-in-oil droplet is infused through the at least one of the inlet(s), flows through at least a portion of the at least one main microchannel, and is withdrawn from at least one of the outlet(s); at least two electrodes comprising notches, wherein a portion of each electrode extends into the main microchannel along a portion of the length of the main microchannel and a portion of each electrode extends outside of the main microchannel for electrical connection; and at least two auxiliary channels wherein a portion of the electrode that extends outside of the main microchannel extends into a portion of an auxiliary channel wherein the auxiliary channel comprises an electrolyte solution, and wherein the at least two electrodes that extend into the same main microchannel do not extend into the same auxiliary channel, wherein the droplet is in simultaneous contact with both electrodes as the droplet flows through and/or is stationary in the main microchannel, and wherein a voltage bias is applied across the electrodes for geometrical confinement of at least one ion enrichment zone and/or at least one ion depletion zone within the droplet. Provided herein is a method of geometrical confinement of at least one ion enrichment zone and/or at least one ion depletion zone within a droplet comprising flowing at least one water-in-oil droplet through at least one main microchannel of the device; and applying a voltage bias across the device for a period of time to geometrically confine at least one ion enrichment zone and/or at least one ion depletion zone within the droplet. In an embodiment the notches provide higher surface area for electromechanical reactions inside the droplet. In an embodiment, redox reactions at the electrode edges regulate and/or define ion depletion zone and ion enrichment zone shape and propagation.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an illustration of desalting a droplet. This illustration shows a top-down view of a portion of a main microchannel comprising a W/O droplet, wherein the main microchannel is separated from two parallel auxiliary channels (“aux channel”) by the walls of the device. A cation-exchange membrane (“CEM”) and an anion-exchange membrane (“AEM”) are patterned underneath the channel walls such that each membrane spans a portion of the main microchannel and an auxiliary channel, contacting the droplet at opposing sides. A voltage bias, denoted by a “+” in one auxiliary channel and a “−” in the other, is applied across the system. Cations and anions simultaneously migrate out of the droplet through the respective permselective membranes and into opposite auxiliary channels.

FIG. 2 is an illustration of salting a droplet. This illustration shows a top-down view of a portion of a main microchannel comprising a W/O droplet, wherein the main microchannel is separated from two parallel auxiliary channels (“aux channel”) by the walls of the device. A cation-exchange membrane (“CEM”) and an anion-exchange membrane (“AEM”) are patterned underneath the channel walls such that each membrane spans a portion of the main microchannel and an auxiliary channel, contacting the droplet at opposing sides. A voltage bias, denoted by a “+” in one auxiliary channel and a “−” in the other, is applied across the system. Cations and anions simultaneously migrate out of the auxiliary channels through the respective permselective membranes and into the droplet.

FIG. 3A through FIG. 3D illustrate the process workflow for device fabrication.

FIG. 3A depicts the first step in the device preparation procedure wherein both the microfluidic channels subsequently utilized for flow-patterning the membrane and the microfluidic channels comprising the main and auxiliary channels are each patterned by a caste-mold process into a PDMS monolith.

FIG. 3B depicts the second step in the device preparation procedure wherein the microfluidic channels defining the membrane pattern are placed on the glass slide and then the precursor for the permselective membranes is injected through punch holes that define the inlets to the microchannels. One is a cation-permselective membrane and the other is an anion-permselective membrane.

FIG. 3C depicts the third step in the device preparation procedure wherein the permselective membranes are baked in an oven and then cured on a hot plate followed by the removal of the PDMS monolith that defines the microchannels.

FIG. 3D depicts the fourth step in the device preparation procedure wherein the PDMS monolith imprinted with the main and auxiliary channels is aligned on top of the permselective membranes such that each membrane contacts both the main channel and an auxiliary channel.

FIG. 4A shows a brightfield image of a droplet containing a CaCl₂ solution taken before the application of a voltage bias in the desalting mode. The auxiliary channels are filled with a AgNO₃ solution. The droplet is wetted by the cation-permselective membrane at the top and by the anion-permselective membrane at the bottom.

FIG. 4B shows a brightfield image of a droplet containing a CaCl₂ solution taken after application of a voltage bias in the desalting mode. The auxiliary channels are filled with a AgNO₃ solution. The droplet is wetted by the cation-permselective membrane at the top and by the anion-permselective membrane at the bottom. The box highlights AgCl precipitation formed at the anodic membrane-microchannel interface.

FIG. 5A is a green fluorescence micrograph of a droplet containing a CaCl₂ solution spiked with Bodipy²⁻ in the absence of voltage application.

FIG. 5B is a green fluorescence micrograph of a droplet containing a CaCl₂ solution spiked with Bodipy²⁻ during the application of 50V.

FIG. 6 shows the current transients obtained over three trials for droplets comprising sodium phosphate buffer solution under the desalting mode with 30V applied voltage.

FIG. 7A shows the current transients obtained under distinct applied voltages in the desalting mode for desalting a stationary set of droplets comprising sodium phosphate buffer.

FIG. 7B shows the maximum current obtained under distinct applied voltages in the desalting mode for desalting a stationary set of droplets comprising sodium phosphate buffer.

FIG. 7C shows the time taken to accomplish desalting droplets comprising sodium phosphate buffer spiked with Bodipy²⁻. The time taken to accomplish desalting was determined by the time taken to completely deplete the fluorophore from the droplets.

FIG. 8 shows the current transients obtained for a stationary set of droplets with two distinct ionic concentrations under 30V applied voltage in the desalting mode.

FIG. 9 shows the current transients obtained for continuously flowing droplets under distinct applied voltages in the desalting mode.

FIG. 10A shows a brightfield image of a droplet containing a CaCl₂ solution taken before application of a voltage bias in the salting mode. The auxiliary channels are filled with a AgNO₃ solution. The droplet is wetted by the cation-permselective membrane at the top and by the anion-permselective membrane at the bottom.

FIG. 10B shows a brightfield image of a droplet containing a CaCl₂ solution taken after application of a voltage bias in the salting mode. The auxiliary channels are filled with a AgNO₃ solution. The droplet is wetted by the cation-permselective membrane at the top and by the anion-permselective membrane at the bottom. The AgCl precipitation formation is observed in the droplet.

FIG. 11A shows a brightfield micrograph of a device with notched auxiliary microchannel walls taken before the application of a voltage bias in the desalting mode. The cation-selective membrane is indicated by CEM and the anionic selective membrane is indicated by AEM.

FIG. 11B shows a brightfield micrograph of a device with notched auxiliary microchannel walls taken after the application of a voltage bias in the desalting mode. The red boxes highlight specific notches where precipitation occurred, and the blue box indicates a notch where there is no precipitation.

FIG. 12 shows the current transients obtained over three trials for a stationary set of droplets under an applied voltage of 30V in the salting mode.

FIG. 13A shows the current transients obtained under distinct voltages applied in the salting mode.

FIG. 13B shows the maximum current corresponding to distinct voltages applied in the salting mode.

FIG. 14 shows the current transients obtained for continuously flowing droplets undergoing salting under three distinct applied voltages.

FIG. 15A shows an image of a droplet taken before the application of a voltage bias in the desalting mode. The droplet encapsulates negatively charged 2 μm polystyrene carboxylate beads as indicated by the bright spots within the droplet. The cation-selective membrane is indicated by CEM and the anion-selective membrane is indicated by AEM.

FIG. 15B is an image of the droplet in FIG. 15A taken during the application of a voltage bias in the desalting mode. The arrows show the direction of bead movement with desalting, toward the anion-permselective membrane.

FIG. 15C is an image of the droplet in FIG. 15B after time under constant applied desalting voltage. The beads move further towards the anion-permselective membrane.

FIG. 15D is an image of the droplet in FIG. 15C after further time under constant applied desalting voltage. Most of the encapsulated beads adhere to the anion-permselective membrane, unable to escape the droplet due to their size.

FIG. 16A shows an image of a droplet taken before the application of a voltage bias in the desalting mode. The droplet comprises a dye-linked large biomolecule-AlexaFluor488-linked Rabbit IgG. The cation-selective membrane is indicated by CEM and the anion-selective membrane is indicated by AEM.

FIG. 16B is an image of the droplet in FIG. 16A taken during the application of a voltage bias of 40V in the desalting mode.

FIG. 16C is an image of the droplet in FIG. 16B after time under constant applied desalting voltage. The large biomolecule is not completely depleted out of the droplet.

FIG. 17 shows a brightfield micrograph of a device with notched cation permselective membranes on either side of the droplet. The blue dotted line shows a part of the patterned membrane. The purple dotted line in the first droplet shows the location of IEZ generation and confinement. The black dotted line in the first droplet shown the location of IDZ confinement.

FIG. 18A is an image showing droplets containing fluorescent tracer dye bound by notched membranes on opposing sides, in the absence of an electric field. The membrane notches correspond to the subtle droplet deformation on either end.

FIG. 18B is an image showing droplets containing fluorescent tracer dye bound by notched membranes on opposing sides, with applied voltage. The ion depletion zones (“IDZ”) and ion enrichment zones (“IEZ”) are confined around the notched edges of the membranes.

FIG. 19 is a brightfield image showing droplets in a device with notched electrodes in place of the membranes.

FIG. 20A is an image of droplets containing fluorescent tracer dye bound by notched electrodes on opposing sides, without applied voltage.

FIG. 20B is an image of droplets containing fluorescent tracer dye bound by notched electrodes on opposing sides, with applied voltage. Redox reactions at the electrode edges regulate/define IDZ and IEZ shape and propagation.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE INVENTION

The embodiments described herein are not limited to any particular device or method of using the device, which can vary and are understood by skilled artisans based on the present disclosure herein. It is further to be understood that all terminology used herein is for the purpose of describing particular embodiments only, and is not intended to be limiting in any manner or scope. For example, as used in this specification and the appended claims, the singular forms “a,” “an,” and “the” can include plural referents unless the content clearly indicates otherwise. Further, all units, prefixes, and symbols may be denoted in its SI accepted form.

Numeric ranges recited within the specification are inclusive of the numbers within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range (e.g. 1 to 5 includes 1, 1.5, 2, 2.75, 3, 3.80, 4, and 5).

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation. The preferred materials and methods are described herein. In describing and claiming the embodiments of the present invention, the following terminology will be used in accordance with the definitions set out below.

The term “about,” as used herein, refers to variations in size, distance or any other types of measurements that can be resulted from inherent heterogeneous nature of the measured objects and imprecise nature of the measurements itself. The term “about” also encompasses variation in the numerical quantity that can occur, for example, through typical measuring or handling procedures in the real world; through inadvertent error in these procedures; through differences in the manufacture, source, or purity of the ingredients used to make the device or carry out the methods, and the like. Whether or not modified by the term “about”, the claims include equivalents to the quantities.

Microfluidic Devices

In one embodiment, the present disclosure provides a microfluidic device for extracting ions from water-in-oil (“W/O”) droplets. In another embodiment, the present disclosure provides a microfluidic device for introducing ions into a W/O droplet. In a further embodiment, the present disclosure provides a microfluidic device for both extracting ions from a droplet and introducing ions into a droplet.

The device comprises at least one inlet and at least one outlet, both in fluid connection with at least one main microchannel. The one or more fluidic main microchannels retain and move a solution comprising W/O droplets from inlet to outlet. Each main microchannel further comprises at least one cation-permselective membrane and at least one anion-permselective membrane. A portion of each permselective membrane extends into the main microchannel and along at least a portion of the length of the main microchannel for contact with the droplets retained within and/or moving through the main microchannel. Another portion of each permselective membrane extends outside of the main microchannel for to maintain ionic communication. In an embodiment, the cation-permselective membrane and the anion-permselective membrane are not in physical contact with each other. In an embodiment, the cation-permselective membrane and the anion-permselective membrane each extend into the main microchannel at opposite sides of the main microchannel.

In an embodiment, the permselective membrane portion that extends outside of the main microchannel extends into a portion of an auxiliary channel, the auxiliary channel comprising an electrolyte solution. In an embodiment, an electrode is immersed in the electrolyte solution in the auxiliary channel for electrical connection.

In an embodiment, more than one main microchannel is connected in series or in parallel with at least one other main microchannel, in fluid connection with the same or distinct inlet(s) and/or outlet(s). In an embodiment, a number of main microchannels may be grouped together and connected fluidly with another group or groups of microchannels. Within each group of microchannels any two main microchannels can be parallel to each other, on top of each other, or in another arrangement. A group of main microchannels may be in fluid connection with a singular inlet or many inlets. A group of main microchannels may be in fluid connection with a singular outlet or many outlets. In an embodiment, each main microchannel has unique cation and/or anion-permselective membranes. In an embodiment, each main microchannel may have a unique set of auxiliary channels or the same auxiliary channel as any other main microchannel. In another embodiment, any one auxiliary channel may have a unique electrolyte solution, or the same electrolyte solution as any other auxiliary channel. Many main microchannels may have permselective membranes that extend into the same auxiliary channel.

In an embodiment, the main microchannel and the droplet are of the size and dimension such that the droplet is in physical contact with at least one cation-permselective membrane and at least one anion-permselective membrane. In an embodiment, the cation-permselective membrane and the anion-permselective membrane contact the droplet at opposing sides of the droplet. In an embodiment, as the W/O droplet(s) move from inlet to outlet, a voltage bias is applied across the permselective membranes that extend into the main microchannel. In an embodiment, the voltage is applied to the electrolyte solution in the auxiliary channels using driving electrodes. In another embodiment, the voltage is applied to an electrode or other electrical contact in connection with the permselective membrane.

In an embodiment, a voltage bias is applied across the device to extract ions from the droplet (“desalting”). In an embodiment, a voltage bias is applied across the device to introduce ions into the droplet (“salting”).

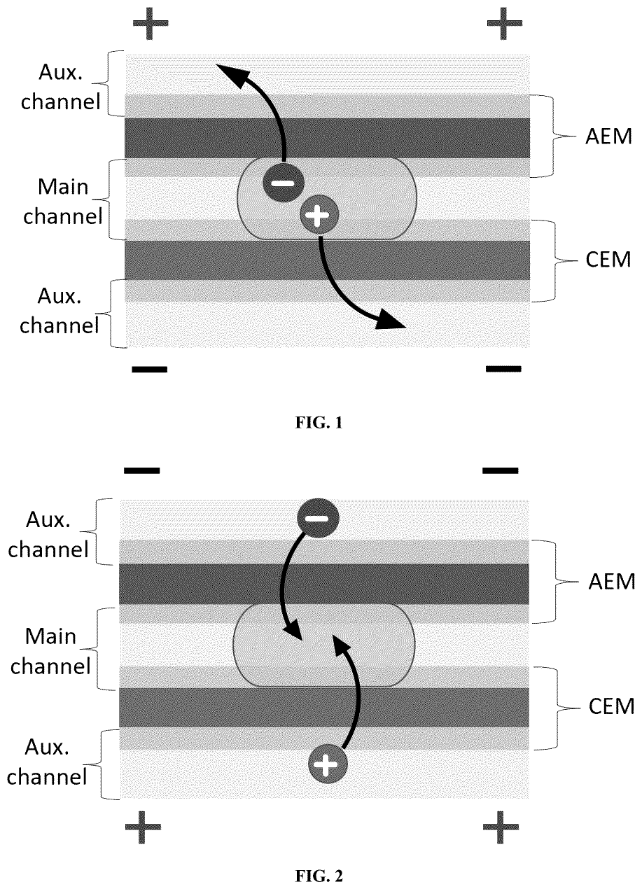

An exemplary device for desalting is illustrated in FIG. 1. FIG. 1 illustrates a top-down view of a portion of a main microchannel comprising a W/O droplet. The walls of the main microchannel separate the main microchannel from two parallel auxiliary channels. A cation-permselective membrane, also referred to as a cation-exchange membrane, is illustrated in blue and labeled “CEM”. An anion-permselective membrane, also referred to as an anion-exchange membrane, is illustrated in red and labeled “AEM”. The permselective membranes run parallel to the main microchannel and an auxiliary channel with a portion of the membrane extending into the main microchannel and the auxiliary channel. A voltage bias is applied across the permselective membranes via driving electrodes in the auxiliary channels illustrated by a “+” in one auxiliary channel and a “−” in the other. In the desalting embodiment, the cation-permselective membrane is in connection with a cathodic auxiliary microchannel, while the anion-permselective membrane is in connection with an anodic auxiliary microchannel. When a voltage bias is applied across the device, cations within the droplet migrate out of the droplet, through the cation-selective membrane, and into the cathodic auxiliary channel (toward the cathode). When a voltage bias is applied across the device, anions within the droplet migrate out of the droplet, across the anionic membrane and into the anodic auxiliary microchannel.

An exemplary device for salting is illustrated in FIG. 2. FIG. 2 illustrates a top-down view of a portion of a main microchannel comprising a W/O droplet. The walls of the main microchannel separate the main microchannel from two parallel auxiliary channels. A cation-permselective membrane, also referred to as a cation-exchange membrane, is illustrated in blue and labeled “CEM”. An anion-permselective membrane, also referred to as an anion-exchange membrane, is illustrated in red and labeled “AEM”. The permselective membranes run parallel to the main microchannel and an auxiliary channel with a portion of the membrane extending into the main microchannel and the auxiliary channel. A voltage bias is applied across the permselective membranes via driving electrodes in the auxiliary channels illustrated by a “+” in one auxiliary channel and a “−” in the other. In the salting embodiment, the cation-permselective membrane is in connection with an anodic auxiliary microchannel, while the anion-permselective membrane is in connection with a cathodic auxiliary microchannel. When a voltage bias is applied across the device, cations migrate out of the anodic auxiliary channel, through the cation-selective membrane, and into the droplet. When a voltage bias is applied across the device, anions migrate out of the cathodic auxiliary channel, through the anion-permselective membrane and into the droplet.

In an embodiment, a main microchannel comprises segments in which a droplet is in contact with permselective membranes according to FIG. 1, and segments wherein the cation- and anion-permselective membranes are on opposite sides of the droplet (reversed). In such an embodiment, as a droplet flows through a main microchannel with the device under a voltage bias, desalting and salting of the droplet occur within the same main microchannel.

In an embodiment, a main microchannel comprises segments in which a droplet is in contact with permselective membranes according to FIG. 2, and segments wherein the cation- and anion-permselective membranes are in on opposite sides of the droplet (reversed). In such an embodiment, as a droplet flows through a main microchannel with the device under a voltage bias, salting and desalting of the droplet occur within the same main microchannel.

In an embodiment, a voltage bias across the device is reversed as a droplet flows through a main microchannel wherein salting and/or desalting of the droplet occurs within the same main microchannel.

In an embodiment, the membranes on opposing sides of a droplet are both cation-permselective or both anion-permselective. Such an embodiment may provide for monodirectional or unified salting and/or desalting wherein both salting and/or desalting occur at the same time within a droplet.

In an embodiment, the device further comprises a power source connected with the driving electrodes, wherein the power source is configured to supply a voltage in the range of from about 50 mV to about 500 V. In an aspect, the power source is a battery.

In an embodiment, the device of the current disclosure comprises a device for uniform droplet flow through a main microchannel. Uniform flow may be ensured by any method commonly known in the art. In an embodiment, uniform pressure driven flow is ensured by a pump at an inlet to infuse into the device and/or a pump at an outlet to withdraw the solution from the device. In an embodiment, the droplets are infused into the inlet by a syringe and/or similarly withdrawn from the outlet using a syringe. In an aspect, the syringe is attached to tubing. In an aspect, droplet flow rate through a main microchannel is regulated by any known method in the art and further may be monitored and/or controlled with an inline flow rate sensor. In an embodiment, the droplet flow rate is from about 0.0 μm/s to about 5000 μm/s. In an embodiment, the device of the current disclosure comprises a droplet generator. In an embodiment, the droplet generator is in fluid connection with the inlet of a main microchannel. In an embodiment, the droplets are generated in a droplet generator and then seamlessly flow into the main microchannel as one unit. In an aspect the droplet generator generates W/O droplets according to the method described herein and controls droplet flow through the main microchannel.

In an embodiment, the outlet of the main microchannel may connect to one or more microchannel or group of microchannels, and/or may connect to a droplet splitter such as a Y junction, and/or may be an outlet such that the droplets are collected for analysis or further processing. In an embodiment, the outlet is the end of a microchannel. In an embodiment, the droplet is withdrawn from the microchannel via the outlet. In an embodiment, the droplet is withdrawn from the device via the outlet.

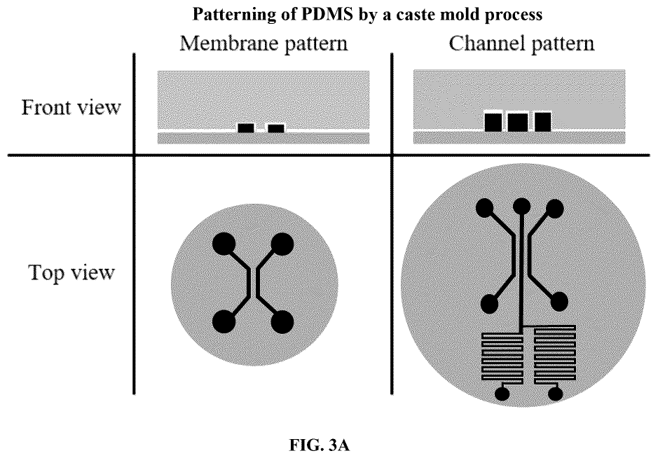

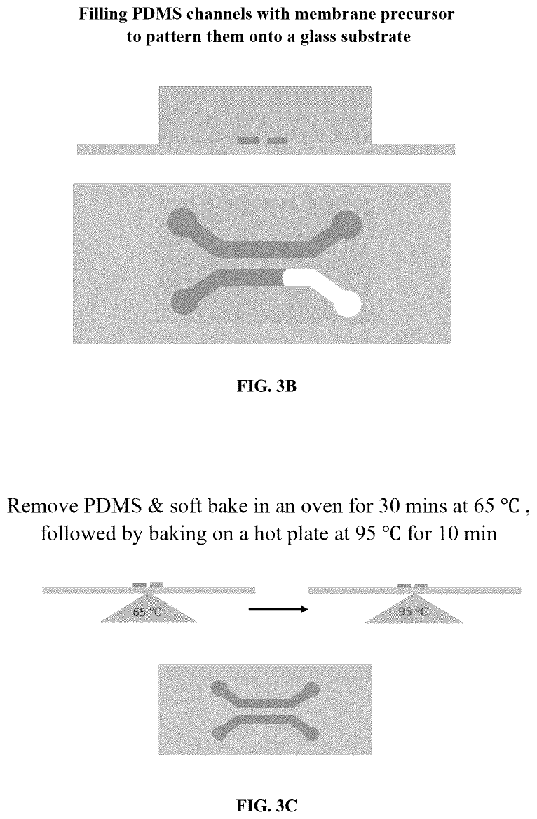

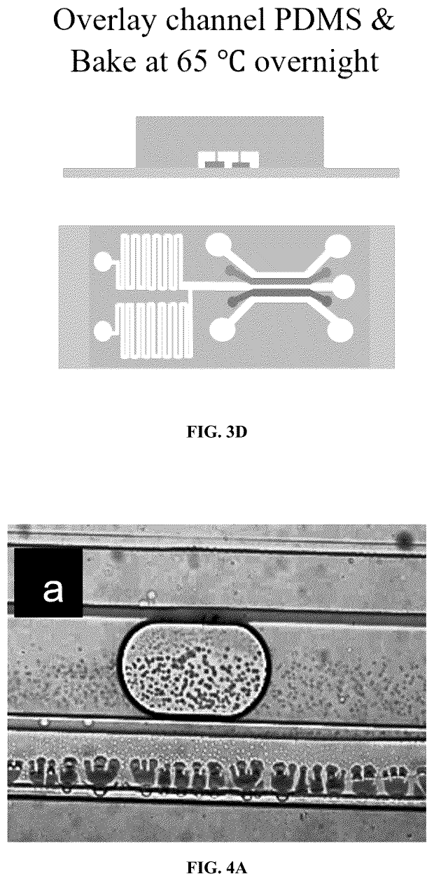

A simplified example of a microfluidic device construction is illustrated by FIG. 3A, FIG. 3B, FIG. 3C, and FIG. 3D. As depicted in green in FIG. 3A, a PDMS monolith is cast-molded on a Si wafer. The PDMS is imprinted with two channels. Then, the PDMS monolith is reversibly sealed to a glass slide. Permselective membrane resin is pipetted on top of the inlet of each channel and then pulled through by suction applied to the outlet as depicted in FIG. 3B. Then, the glass slide is baked and the permselective membranes cured on a hot plate as depicted in FIG. 3C. The PDMS used to pattern the membranes is peeled away leaving cured permselective membranes on the slide glass.

Separately, as depicted in orange in FIG. 3A, a PDMS monolith defining three microchannels is fabricated by soft lithography from a patterned Si wafer. The central main microchannel comprises a droplet generator that contains the inlets. These auxiliary and main microchannels are aligned on top of the membranes as depicted in FIG. 3D and baked to improve bonding. Note that the channels are aligned parallel to the membranes and centered on them such that each membrane spans the wall between an auxiliary channel and the main channel. The oil and aqueous phases are infused via the inlets of the droplet generator, eventually forming W/O droplets that are flowed into the main channel. The auxiliary channels are filled with an aqueous electrolyte.

Main Microchannel

As used herein, a microchannel is a passageway from at least one inlet to at least one outlet wherein fluid flows from inlet to outlet. As used herein, a main microchannel is the microchannel wherein W/O droplets flow from inlet to outlet and undergo desalting and/or salting. As used herein, the length of a microchannel is the distance from inlet to outlet through the microchannel along the intended path of fluid flow. As used herein, the width of a microchannel is the horizontal distance of two points that are on the opposite edges of the cross-section perpendicular to the intended fluidic flow and are furthest away from each other. As used herein, the height of a microchannel is the vertical distance from the floor of a microchannel to the ceiling of the same.

As used herein, the main microchannel is referred to as having any width and height necessary to transport pico- to nano-liter scale W/O droplets. In an embodiment, the width of a main microchannel is from about to about 10 μm to about 1000 μm. In an embodiment, the height of a microchannel is from about 10 μm to about 1000 μm. The cross-section of a microchannel can have any two-dimensional shape, such as square, rectangular, circle, or a combination thereof. The length of a microchannel can be any length sufficient to allow in-droplet enrichment. In an embodiment, the length of a microchannel is from about 1.0 mm to about 100 mm. A microchannel may be straight or curved.

In an aspect, the walls, floor, and ceiling of the main microchannel of the device described herein can be composed of any material that will retain and move a solution comprised of W/O droplets from at least one inlet to at least one outlet. In an aspect, the main microchannel is not conductive other than any portion of the main microchannel that comprises a permselective membrane. In some embodiments, the walls, floor, and/or ceiling of the main microchannel comprise a polymeric material. In an embodiment, the walls, floor, and/or ceiling the main microchannel is comprised of polydimethylsiloxane (“PDMS”), polymethylmethacrylate (“PMMA”), polystyrene, polycarbonate, cyclic olefin polymer, cyclic olefin copolymer, pressure sensitive adhesive tape, silicon, glass or the like. In an embodiment, the walls, floor, and/or ceiling of the microchannels comprise the resin of a 3D printer. In an embodiment, the walls, floor, and/or ceiling of the microchannels comprise polyethylene glycol. In another embodiment, the walls of the microchannel comprise crosslinked polyethylene glycol diacrylate (“PEGDA”) resin.

W/O Droplets

As used herein, a droplet is a pico- to nano-liter scale droplet. In an embodiment, the droplet comprises charged species in an aqueous solution. An aqueous solution is encapsulated in droplets suspended within an oil continuous phase. As used herein, water-in-oil means the encapsulated droplets as described herein are suspended in a continuous oil phase. The droplets suspended in oil are in fluidic flow from at least one inlet through at least a portion of one main microchannel of the device described herein and to at least one outlet. In an embodiment, the volume of the droplets is from about 10 pL to about 50.0 nL. In an embodiment, the diameter of the droplets is from about 10 μm to about 1000 μm.

In an embodiment, the droplets comprise reaction reagents and/or an analyte. In an embodiment, droplets comprise charged species such as proteins, antigens, bioparticles, bacteria, virus, nucleic acids, enzymes, biological cells, DNA, RNA, aptamers, antibodies, peptides, peptide nucleic acids, morpholino oligonucleotides, receptors, other bioparticles, other nano/micro particles, molecules, polyatomic ions, atomic ions or a combination thereof. In an embodiment, the aqueous solution within the droplet comprises blood, blood plasma, saliva, urine, sweat, tears, or any other such biofluid or any combination thereof.

In an embodiment, the droplets comprise an electrolyte solution. As used herein an electrolyte solution is an electrically conducting solution comprising dissolved ions. In an embodiment, the electrolyte solution comprises a buffer. As used herein, a buffer is a solution that resists a shift in pH that would otherwise be cause by addition of an acid or base. This disclosure is meant to incorporate any electrolyte solution and/or buffer solution as commonly known to the skilled artisan. In an embodiment, the electrolyte solution comprises NaCl, KCl, Na₂SO₄, HCl, H₂SO₄, NaOH, KOH, NaNO₃, KNO₃ and/or combinations thereof. In an embodiment, the electrolyte solution comprises phosphate buffer, carbonate buffer, acetate buffer, borate buffer, Tris buffer, HEPES (4-(2-hydroxyethyl)-1-piperazineethanesulfonic acid), MOPS (3-(N-morpholino) propanesulfonic acid), TAE (Tris-acetate-EDTA), PIPES (piperazine-N,N′-bis(2-ethanesulfonic acid), tricine buffer, PBS (phosphate buffered saline) and/or combinations thereof. In an embodiment the droplets comprise an electrolyte solution utilized as a “background” electrolyte solution that comprises an analyte targeted for enrichment and/or separation. As used herein “background” refers to the contents of the droplet other than the charged particles intended for concentration enrichment and/or separation.

Permselective Membrane

As used herein, a permselective membrane is a semi-permeable membrane that allows transport of certain dissolved ions, while blocking other ions or neutral species. The selectivity of the membrane is due to Donnan exclusion or a Dukhin number much greater than about 1. The permselective membrane may be cation or anion selective. Preferred permselective membranes include, but are not limited to, cation-permselective Nafion™ membranes distributed by the Chemours Company and anion-permselective Sustainion® membranes distributed by Dioxide Materials.

The permselective membrane as described herein may have any size or dimension such that a portion extends into the main microchannel for contact with the droplets and another portion extends outside of the channel for electrical connection. As used herein, the length of a permselective membrane is the distance the membrane spans the length of the main microchannel along the intended fluid flow. In an embodiment, the permselective membrane extends into the main microchannel for the entire length of the main microchannel. In another embodiment, the permselective membrane extends into the main microchannel for at least about half the length of the main microchannel. In another embodiment, the permselective membrane extends into the main microchannel for at least about three-quarters of the length of the main microchannel. As used herein, the width of a permselective membrane is the horizontal distance of two points that are on the opposite edges of the cross-section of the membrane perpendicular to the intended fluidic flow and are furthest away from each other. As used herein, the thickness of a permselective membrane is the vertical distance from the bottom of a permselective membrane to the top of the same. In an embodiment, the width of a permselective membrane is from about to about 50 μm to about 1000 μm. In an embodiment, the thickness of a permselective membrane is from about 1.0 μm to about 50 μm. The cross-section of a permselective membrane can have any two-dimensional shape, such as square, rectangular, circle, or a combination thereof. The length of a permselective membrane can be any length sufficient to allow in-droplet concentration enrichment, separation, and/or cation exchange. In an embodiment, the length of a permselective membrane is from about 1.0 mm to about 100 mm. A permselective membrane may be straight or curved or have any top-down shape.

In an embodiment the main microchannel is part of a sequence of droplet manipulation modules wherein a desalting and/or salting module is one of many. In this embodiment, any permselective membrane contacts a small portion of the main microchannel. In an embodiment, the permselective membrane extends into the main microchannel for about 1% to about 50% of the main microchannel. In an embodiment, the permselective membrane extends into the main microchannel for about 1% to about 10% of the main microchannel. In an embodiment, the permselective membrane extends into the main microchannel for about 1% to about 5% of the main microchannel.

In an embodiment the cation-selective membrane and the anion-selective membrane comprise a pore size, in addition to the chemistry of the membrane material used, that regulates the filtration of ions through the membrane. Ions larger than the pore size will not migrate through membrane. In an embodiment, the pore size is selected to exclude ions of a certain size from migrating into the droplet from the auxiliary channel. In an embodiment, the pore size is selected to exclude ions of a certain size from migrating from the droplet and into the auxiliary channel. In an embodiment, proteins are excluded from migrating from the droplet and into the auxiliary channel.

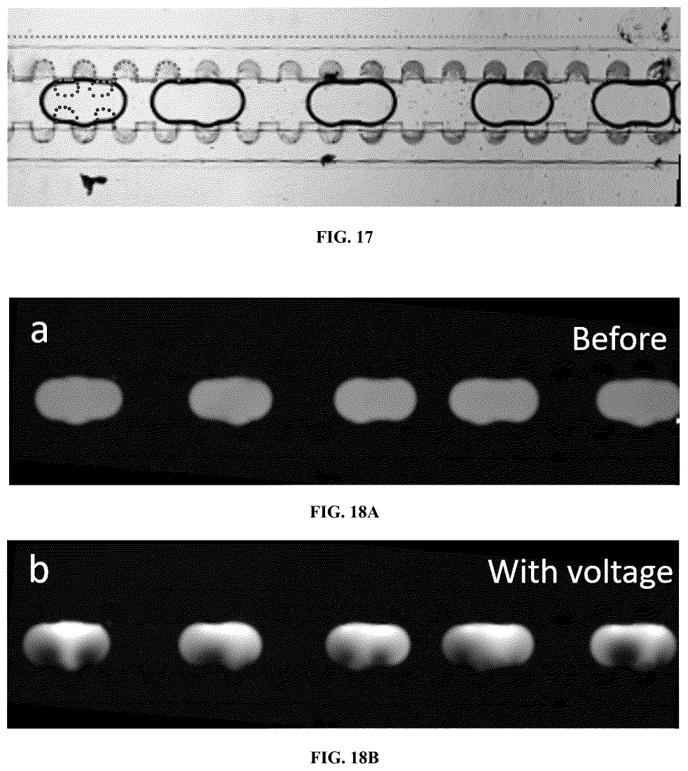

In an embodiment, at least one edge at least one membrane comprises notches. As used herein notches include a portion of a membrane that extrudes into or away from the main portion of the membrane, and can be referred to as teeth, or a sawtooth pattern, rectangular steps, spikes, and may comprise any other shape. A notch may provide a defined site for introducing or extracting ions. An example of a membrane comprising notches is illustrated in FIG. 17, wherein the blue dotted line outlines a part of the patterned membrane. Notches may or may not be uniform in shape, size or placement. In an embodiment, notches are of the same size and uniformly placed along the edge of a membrane. In an embodiment, only a portion of a membrane comprises notches. In an embodiment, the notches are not uniform in shape, size or placement.

In an embodiment, in any of the devices or methods disclosed herein, any portion or segment of any membrane is replaced with an electrode. The electrode may comprise, but is not limited to, gold (Au), silver (Ag), and/or platinum (Pt), alloys such as stainless steel or titanium/tungsten (Ti/W), copper, nickel, glassy carbon, pyrolyzed photoresist, silver/silver chloride (Ag/AgCl). In another embodiment, the electrode comprises semi-conductive material, boron-doped diamond, or n-doped or p-doped silicon, or a combination thereof. In an embodiment, the electrode is gold. In an embodiment, at least one edge at least electrode comprises notches. As used herein notches include a portion of an electrode that extrudes into or away from the main portion of the electrode, and can be referred to as teeth, or a sawtooth pattern, rectangular steps, spikes, and may comprise any shape. An example of a membrane comprising notches is illustrated in FIG. 17. Notches may or may not be uniform in shape, size or placement. In an embodiment, notches are of the same size and uniformly placed along the edge of a membrane. In an embodiment, only a portion of a membrane comprises notches. In an embodiment, the notches are not uniform in shape, size or placement.

Auxiliary Microchannels

In an embodiment, the portion of a permselective membrane that extends outside of the main microchannel for electrical connection extends into an auxiliary microchannel which comprises an electrolyte solution. Auxiliary microchannels are separate from the main microchannel, and each main microchannel has at least two, one for the cation-permselective membrane and one for the anion-permselective membrane. In an embodiment, driving electrodes are in electrical connection with the electrolyte solution within the auxiliary channel to drive the voltage bias across the permselective membranes.

In an aspect, auxiliary microchannels can be any size, shape, and/or dimension such that the auxiliary microchannel accommodates an electrolyte solution in connection with at least a portion of the permselective membrane and also accommodates driving electrodes for voltage bias application. In an embodiment, auxiliary channels run parallel to at least a portion of the main microchannel. In an embodiment, each main microchannel has a unique set of auxiliary microchannels. In another embodiment, a portion of the permselective membrane extending outside of more than one microchannel also extends a portion of the permselective membrane into the same auxiliary channel. In an embodiment, the permselective membrane of several microchannels extend into one auxiliary microchannel. In some embodiments, a main microchannel and an auxiliary channel share a common wall, floor, and/or ceiling.

As used herein, an auxiliary microchannel is referred to as having any width, length, and height necessary to comprise an electrolyte solution. In some embodiments, the auxiliary microchannel has any width, length, and height necessary for a portion of the permselective membrane to extend into the auxiliary channel for electrical connection. In some embodiments, the auxiliary microchannel has any width, length, and height necessary for a driving electrode to apply a voltage to the permselective membrane. As used herein, the length, width and height of an auxiliary channel relates to the auxiliary channel's orientation as to the main microchannel. As used herein, the length of an auxiliary microchannel is the maximum distance of the auxiliary channel along the intended fluid flow of the main microchannel. As used herein, the width of an auxiliary microchannel is the horizontal distance of two points that are on the opposite edges of the cross-section of the auxiliary channel perpendicular to the intended fluidic flow of the main microchannel and are furthest away from each other. As used herein, the height of an auxiliary microchannel is the vertical distance from the floor of an auxiliary microchannel to the ceiling of the same. In an embodiment, the width of an auxiliary microchannel is from about to about 10 μm to about 1000 μm. In an embodiment, the height of a microchannel is from about 10 μm to about 1000 μm. The cross-section of a microchannel can have any two-dimensional shape, such as square, rectangular, circle, or a combination thereof. The length of an auxiliary microchannel can be any length sufficient to allow droplet salting and/or desalting. In an embodiment, the length of a microchannel is from about 1.0 mm to about 100 mm.

In an embodiment, the walls, floor, and/or ceiling of an auxiliary microchannel of the device described herein can be composed of any material that will retain an electrolyte solution. In an embodiment, the auxiliary microchannel is not conductive. In some embodiments, the walls, floor, and/or ceiling of the main microchannel comprises a polymeric material. In an embodiment, walls, floor, and/or ceiling the auxiliary microchannel is comprised of polydimethylsiloxane (“PDMS”), polymethylmethacrylate (“PMMA”), polystyrene, polycarbonate, cyclic olefin polymer, cyclic olefin copolymer, pressure sensitive adhesive tape, silicon, glass or the like. In an embodiment, the walls, floor, and/or ceiling of the auxiliary microchannels comprise the resin of a 3D printer. In an embodiment, the walls, floor, and/or ceiling of the auxiliary microchannels comprise polyethylene glycol. In another embodiment, the walls of the microchannel comprise crosslinked polyethylene glycol diacrylate (“PEGDA”) resin.

In an embodiment, the auxiliary microchannel comprises an aqueous electrolyte solution. As used herein an electrolyte solution is an electrically conducting solution comprising dissolved ions. In an embodiment, the electrolyte solution comprises a buffer. As used herein, a buffer is a solution that resists a shift in pH that would otherwise be cause by addition of an acid or base. This disclosure is meant to incorporate any electrolyte solution and/or buffer solution as commonly known to the skilled artisan. In an embodiment, the electrolyte solution comprises phosphate buffer, Tris buffer, and/or combinations thereof.

In an embodiment, a portion of the permselective membrane extends into the auxiliary channel for electrical connection. In an embodiment, the auxiliary channel comprises an electrolyte solution and further comprises one or more driving electrodes as a voltage source. In another embodiment, the auxiliary microchannel comprises a conductive epoxy connected to a voltage source. In another embodiment, the permselective membrane is in contact with an electrode for electrical contact to a voltage source. This disclosure is meant to incorporate any electrode and voltage source as commonly known to the skilled artisan.

An exemplary device design comprising auxiliary microchannels comprising an electrolyte solution is shown in FIG. 3D. FIG. 3D illustrates a cross-section and a top-down view. The main microchannel is in the middle, flanked by two auxiliary channels. Two permselective membranes run along each side of the main microchannel and span a portion of the length of the main microchannel and a portion of an auxiliary microchannel.

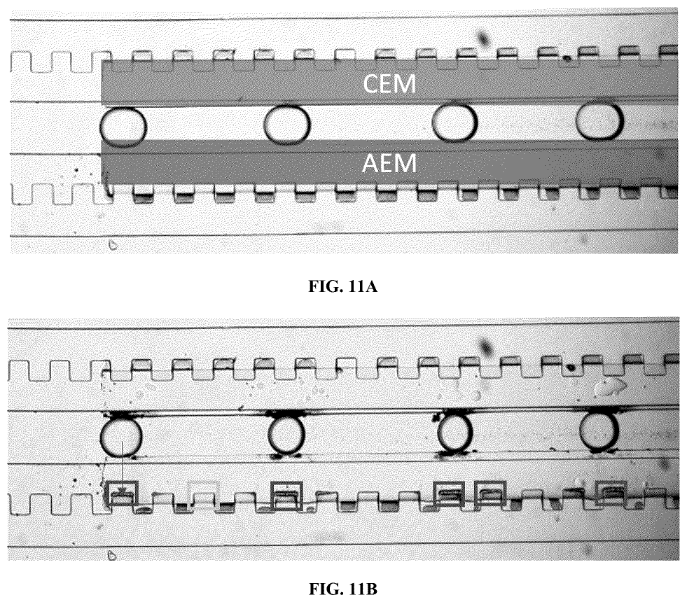

In an embodiment, the walls of an auxiliary microchannel comprise notches. As used herein notches include a portion of a wall that extrude into or away from the main portion of a wall, and can be referred to as teeth, or a sawtooth pattern, or rectangular steps. Mass transport of salted and/or desalted ions is restricted across opposing notches, ions contact the permselective membrane through the notches wherein the membrane is exposed. In an embodiment, the notches provide points of first ionic contact for desalted ions. An example of an auxiliary microchannel wall comprising notches is illustrated in FIG. 11A and FIG. 11B. Notches may or may not be uniform in shape, size or placement. In an embodiment, notches are of the same size and uniformly placed along the auxiliary channel wall. In an embodiment, only a portion of the auxiliary microchannel wall comprises notches. In an embodiment, the notches are not uniform in shape, size or placement.

Methods of Use

Methods described herein are meant to include any and all aspects and embodiments of the device and applications of using the same as described herein. The method that is herein described allows salting and/or desalting of a droplet. This provides, among other things, in-line desalting for droplets in preparation for mass spectrometry, and ion exchange or reagent injection into droplet for forming adducts or derivatives. The devices and methods of using the devices described herein may allow for more rapid, sensitive, and versatile droplet-based synthesis, analysis and/or bioanalysis.

In an embodiment W/O droplets flow through at least one main microchannel and are withdrawn from the outlet. In an embodiment, uniform flow is ensured by any method commonly known in the art. In an embodiment, uniform pressure driven flow is ensured by a pump at an inlet to infuse into the device and/or a pump at an outlet to withdraw the solution from the device. In an embodiment, the droplets are infused into the inlet by a syringe and/or similarly withdrawn from the outlet using a syringe. In an embodiment, the inlet and outlet are open reservoirs wherein uniform flow is gravity-driven, for instance by a fluid height differential, or a larger volume of fluid in the inlet than outlet, or by tilting the device such that the inlet is located in a higher plane than the outlet. In an embodiment, the inlet serves as a port for a larger receptacle to plug into the inlet. In another embodiment, the outlet comprises a receptacle to accept the droplets.

In an embodiment, the outlet is in fluid connection with another device for further droplet processing and/or analysis. In another embodiment, the outlet is in fluid connection with an incubation area. In an embodiment, the incubation area comprises a microchannel wherein temperature is controlled. In an embodiment, the incubation area comprises a temperature controlled microchannel wherein the microchannel is serpentine. In an embodiment, droplets from the outlet of the device and methods described herein improve the sensitivity of subsequent assays as droplets undergo desalting and/or salting just prior to readout.

In an embodiment, droplet flow rate through a main microchannel is regulated by any known method in the art and further may be monitored and/or controlled with an inline flow rate sensor. In an embodiment, droplet flow rate is maintained and regulated by a pump. In another embodiment, droplet flow rate is maintained and regulated by a syringe pump. In an embodiment, the droplet flow rate is from about 0.0 μm/s to about 5000 μm/s. In an embodiment, droplets flow from inlet to outlet in at least about 20 seconds. In another embodiment, droplets flow from inlet to outlet in at least about 15 seconds. In another embodiment, droplets flow from inlet to outlet in at least about 10 seconds. In another embodiment, droplets flow from inlet to outlet in at least about 5 seconds. In another embodiment, droplets flow from inlet to outlet in at least about 1 second.

The devices and methods described herein provide a method for desalting a droplet, as illustrated in FIG. 1. Droplets may be stationary or flowing through the main microchannel. In an embodiment, a voltage bias is applied across the device while droplets are present in the main microchannel. The cation-permselective membrane is in connection with a cathodic auxiliary microchannel, while the anion-permselective membrane is in connection with an anodic auxiliary microchannel. When a voltage bias is applied across the device, cations migrate out of the droplet, through the cation-selective membrane, and into the cathodic auxiliary microchannel. When a voltage bias is applied across the device, anions migrate out of the droplet, through the anionic membrane and into the anodic auxiliary microchannel. In an embodiment, at least one cation and/or at least one anion is extracted from the droplet. In an embodiment, the methods and devices described herein lead to decreasing the ions in the droplet by at least about 10%, at least about 20%, at least about 30%, at least about 40%, at least about 50%, at least about 60%, at least about 70%, at least about 80%, at least about 90%, or at least about 100%. In an embodiment, the extent and/or rate of desalting depends, among other factors, on applied voltage and/or composition of the membrane.

The devices and methods described herein provide a method for salting a droplet, as illustrated in FIG. 2. Droplets may be stationary or flowing through the main microchannel. In an embodiment, a voltage bias is applied across the device while droplets are present in the main microchannel. The cation-permselective membrane is in connection with an anodic auxiliary microchannel, while the anion-permselective membrane is in connection with a cathodic auxiliary microchannel. When a voltage bias is applied across the device, cations migrate out of the anodic auxiliary channel, through the cation-selective membrane, and into the droplet. When a voltage bias is applied across the device, anions migrate out of the cathodic auxiliary channel, through the anionic membrane and into the droplet. In an embodiment, at least one cation and/or at least one anion is introduced into the droplet. In an embodiment, the methods and devices described herein lead to increasing the ions in the droplet in an amount of from at least one ion to a concentration about equal to the concentration of that ion in the electrolyte solution. In an embodiment, the methods and devices described herein lead to increasing the ions in the droplet in an amount of from at least one ion to a concentration of about ten times the concentration of that ion in the electrolyte solution, and every amount in between (e.g. about 50% of the concentration of that ion in the electrolyte solution). In an embodiment, the methods and devices described herein lead to increasing the ions in the droplet by at least about 10%, at least about 20%, at least about 30%, at least about 40%, at least about 50%, at least about 60%, at least about 70%, at least about 80%, at least about 90%, at least about 100%, at least about 200%, at least 500%, or more. In an embodiment, the extent and/or rate of salting depends, among other factors, on applied voltage and/or composition of the membrane.

In an embodiment, the methods described herein provide a method for both salting and desalting a droplet within a singular main microchannel. In an embodiment, the voltage bias is reversed at least once as a droplet flows through at least a portion of a main microchannel, reversing the cathodic and anodic auxiliary microchannels, alternately salting and desalting a droplet. In an embodiment, the voltage bias across the device is reversed at least once, more than once, and/or at least several times to repeat salting and desalting the droplet, and vice versa.

In another embodiment, the main microchannel comprises portions wherein the cation-permselective membrane and the anion-selective membrane reverse positions in the main microchannel to allow for salting and desalting within a singular main microchannel without reversing the voltage bias. In this embodiment, the device comprises at least one portion of a main microchannel according to FIG. 1 and at least one portion of a main microchannel according to FIG. 2.

The devices and methods described herein provide a method for monodirectional, or unified, salting and/or desalting a droplet. In this embodiment, a droplet has at least two cation-permselective membranes or at least two anion-permselective membranes on opposing sides in a main microchannel. Droplets may be stationary or flowing through the main microchannel. In an embodiment, a voltage bias is applied across the device while droplets are present in the main microchannel. When a voltage bias is applied across the device, salting and/or desalting occur at the same time within a droplet. In an embodiment, at least one cation and/or at least one anion is introduced into the droplet. In an embodiment, the methods and devices described herein lead to increasing the ions in the droplet in an amount of from at least one ion to a concentration about equal to the concentration of that ion in the electrolyte solution. In an embodiment, the methods and devices described herein lead to increasing the ions in the droplet in an amount of from at least one ion to a concentration of about ten times the concentration of that ion in the electrolyte solution. In an embodiment, the methods and devices described herein lead to increasing the ions in the droplet by at least about 10%, at least about 20%, at least about 30%, at least about 40%, at least about 50%, at least about 60%, at least about 70%, at least about 80%, at least about 90%, at least about 100%, at least about 200%, at least 500%, or more. In an embodiment, at least one cation and/or at least one anion is extracted from the droplet. In an embodiment, the methods and devices described herein lead to decreasing the ions in the droplet by at least about 10%, at least about 20%, at least about 30%, at least about 40%, at least about 50%, at least about 60%, at least about 70%, at least about 80%, at least about 90%, or at least about 100%. In an embodiment, the extent and/or rate of salting depends, among other factors, on applied voltage and/or composition of the membrane.

Several parameters may influence the time scale and extent of salting and/or desalting a droplet, such as droplet length along the channel axis, velocity of the droplet, electric field strength, bulk concentration of the ion in the droplet and/or the auxiliary channel, and the electrophoretic mobilities of the charged species in the droplet. In an embodiment, the applied voltage is adjusted to modulate the rate of salting and/or desalting. In an embodiment, applied voltage ranges from 50 mV to about 500 V. In an embodiment, the time scale for salting and/or desalting ranges from less than about 1 second to about 100 seconds, or more.

In an embodiment, a method described herein is for ion concentration polarization (“ICP”). Ion concentration polarization (“ICP”) is an electrokinetic phenomenon in which ionic species are locally enriched and depleted at opposing ends of an ion permselective structure or a bipolar electrode under a voltage bias. When propagated with two ion selective membranes in series, neighboring ion enriched and depleted zones result. During ICP, the low ionic conductivity of the ion depleted zone (“IDZ”) leads to a strong local enhancement of the electric field and the formation of concentration and electric field gradients at the IDZ boundary. The devices and methods described herein provide a method for enriching charged particles within a droplet. In an embodiment, at least a portion of a permselective membrane is replaced by an electrode. The electrode may be planar or may comprise notches. In an embodiment, at least a portion of an electrode comprises notches providing higher surface area for electromechanical reactions within a droplet. As droplets flow through the main microchannel a voltage bias is applied creating at least one IDZ and at least one ion enrichment zone (“IEZ”) within the droplet in contact with an electrode on opposing sides.

The devices and methods described herein provide a method for geometrical confinement of at least one IDZ and/or at least one IEZ with a droplet. In this embodiment, a droplet has at least two cation-permselective membranes or at least two anion-permselective membranes on opposing sides in a main microchannel, and/or has two electrodes on opposing sides in a main microchannel. In this embodiment at least a portion of the membranes comprise notches which provide defined sites for introducing and/or extracting ions. In this embodiment, at least a portion of the electrodes comprise notches which provide higher surface area for electromechanical reactions inside a droplet. In an embodiment, a droplet electromechanically modified as described prior to and/or after salting and/or desalting as described herein.

In another aspect, the devices and methods described herein provide a method for enriching and/or separating charged particles within a droplet. In an embodiment, charged particles of varying and/or distinct electrophoretic mobilities are separated within a single droplet. devices and methods utilizing ICP in nanoliter-scale W/O droplets for concentration enrichment and separation of charged compounds from the entire volume of a droplet. It is a further objective of the disclosure to provide devices and methods utilizing ICP for separation of multiple species by mobility of each species.

All publications, patent applications, issued patents, and other documents referred to in this specification are indicative of the level of ordinary skill in the art to which this invention pertains and are herein incorporated by reference to the same extent as if each individual publication or patent application was specifically and individually indicated as incorporated by reference.

Definitions that are contained in text incorporated by reference are excluded to the extent that they contradict definitions in this disclosure.

The present invention is further illustrated by the following examples, which should not be considered as limiting in any way.

### EXAMPLES

Various embodiments of the present invention will be described in detail with reference to the drawings, wherein like reference numerals represent like parts throughout the several views. Reference to Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1: Droplet Desalting

The precipitation reaction of silver chloride (AgCl), as shown in Equation (1) was utilized to evaluate the desalting mechanism. A device was prepared according to the process illustrated by FIG. 3A, FIG. 3B, FIG. 3C, and FIG. 3D with Nafion™ (Sigma-Aldrich, St. Louis, MO) as the cation-permselective membrane (sometimes noted as a cation-exchange membrane or “CEM”) and Sustainion® (Dioxide Materials, Boca Raton, FL) as the anion-permselective membrane (sometimes noted as an anion-exchange membrane or “AEM”). In this Example, the cathodic and anodic auxiliary microchannels were filled with a AgNO₃ solution and the droplet was filled with a CaCl₂ solution. A voltage bias in the desalting mode, as illustrated in FIG. 1, led to the formation of AgCl precipitate at the interface or overlap region between the anion-permselective membrane and the anodic microchannel.

2AgNO₃+CaCl₂→2AgCl+Ca(NO₃)₂ (1)

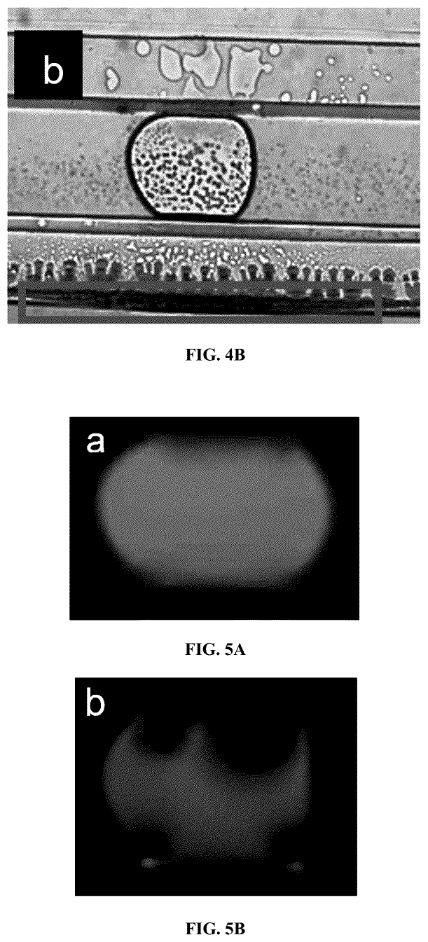

FIG. 4A and FIG. 4B show brightfield micrographs taken before and after the application of a voltage bias in the desalting mode. Formation of the AgCl precipitate was observed at the interface region of the anion-permselective membrane and the anodic auxiliary microchannel, as highlighted by the box in FIG. 4B. The precipitate formation was observed in the region parallel to the droplet and not elsewhere where the oil phase separates the two microchannels. At the cathodic side of the droplet, bubble formation was observed, appearing as dark residues at the cathodic interface, which later disappeared from the system. Bubble formation was anticipated because of the magnitude of the applied voltage, 50V.

An anionic tracer, Bodipy²⁻ (4,4-difluoro-1,3,5,7,8-pentamethyl-4-bora-3a,4a-diaza-S-indacene-2-6-disulfonic acid, Molecular Probes, Eugene, OR) was used to track the ionic concentration distribution with desalting. FIG. 5A and FIG. 5B show green fluorescence micrographs of a droplet containing a CaCl₂ solution spiked with Bodipy²⁻ before and after a voltage application of 50V. As shown in FIG. 5B, the generation of depletion zones, evidenced by the formation of vortices, was observed on both sides of the droplet contacting the membranes, confirming desalting of the droplet.

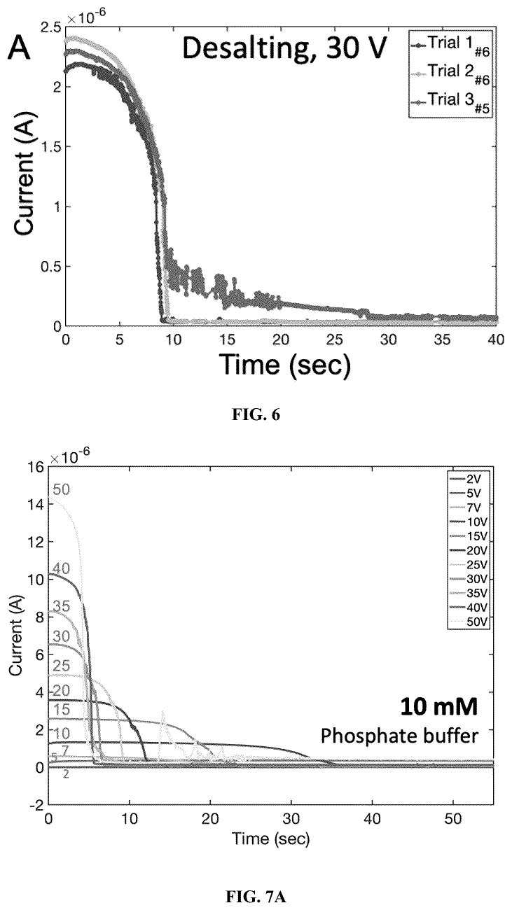

The current transients under the desalting mode were measured across the electrokinetic zone containing a stationary set of droplets. The current transients were found to follow a characteristic three-regime trace denoting the onset, acceleration, and accomplishment of desalting, respectively. FIG. 6 illustrates the current transients obtained over three trials under 30V applied for desalting an average of 5-6 droplets of ˜1 nL volume each.

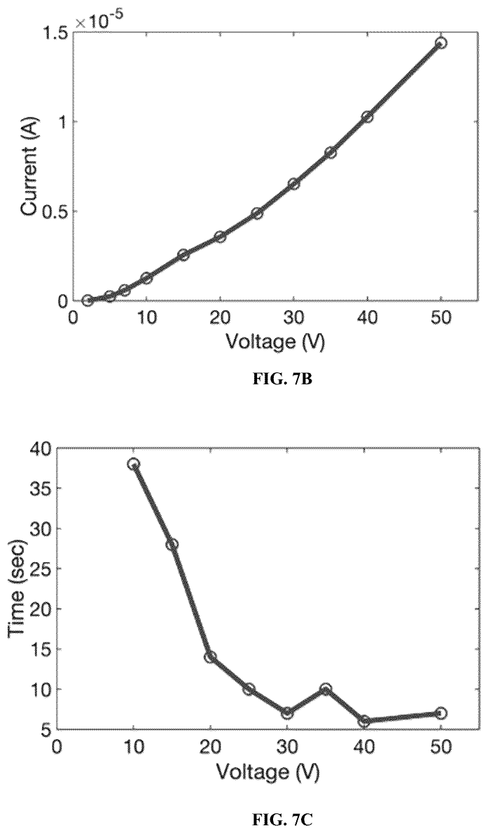

FIG. 7A shows the current transients obtained for desalting droplets comprising 10.0 mM sodium phosphate buffer at distinct voltages. FIG. 7B depicts the maximum current obtained upon the application of distinct voltages. FIG. 7B shows that the rate of desalting is linearly proportional to the applied voltage magnitude.

FIG. 7C indicates the time required to accomplish desalting in droplets comprising 10 mM sodium phosphate buffer spiked with Bodipy²⁻. The time to accomplish desalting was recorded as the time taken to completely deplete the droplets of the fluorophore. From FIG. 7C, it was observed that the time taken to accomplish desalting was inversely proportional to the applied voltage. Therefore, under a higher applied voltage, desalting was accomplished more readily (faster).

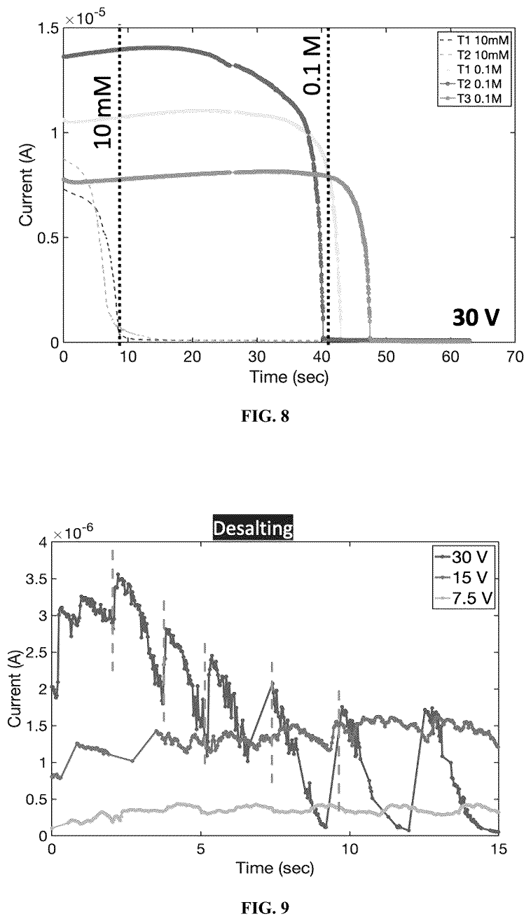

FIG. 8 shows the current transients obtained for a stationary set of droplets with two distinct ionic concentrations under 30V applied voltage in the desalting mode. From FIG. 8, it was observed that the time required for desalting droplets having a higher ionic concentration (0.1 M) was lower compared to that required to desalt droplets having a lower ionic concentration (10.0 mM).

FIG. 9 shows the current transients obtained for continuously flowing droplets under three distinct applied voltages (30V, 15V, and 7.5V) for desalting. From FIG. 9, it was observed that the current transients were periodic with more dramatic current shifts observed for 30V compared to 15V and the least dramatic periodic current shifts at 7.5V.

### Example 2: Droplet Salting

The precipitation reaction of silver chloride (AgCl), as shown in Equation (1) above was utilized to evaluate salting mechanisms. A device was prepared according to the process illustrated by FIG. 3A, FIG. 3B, FIG. 3C, and FIG. 3D with Nafion™ (Sigma-Aldrich, St. Louis, MO) as the cation-permselective membrane (sometimes noted as a cation-exchange membrane or “CEM”) and Sustainion® (Dioxide Materials, Boca Raton, FL) as the anion-permselective membrane (sometimes noted as an anion-exchange membrane or “AEM”). In this Example, the cathodic and anodic auxiliary microchannels were filled with a AgNO₃ solution and the droplet was filled with a CaCl₂ solution. A voltage bias in the salting mode, as illustrated in FIG. 2, led to the formation of AgCl precipitate in the droplet.

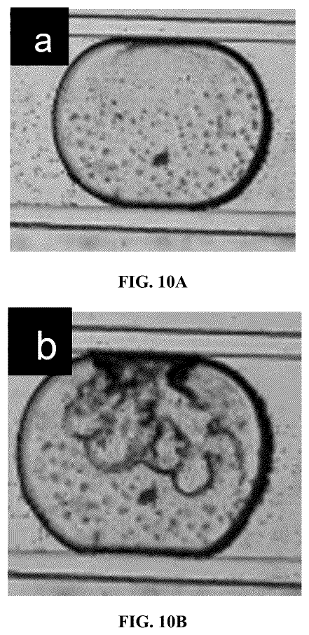

FIG. 10A and FIG. 10B show brightfield micrographs of a droplet taken before and after the application of a voltage bias in the salting mode. As shown in FIG. 10B, formation of the AgCl precipitate was observed within the droplet, confirming salting of the droplet.

### Example 3: Structured Walls

A device was prepared according to the process illustrated by FIG. 3A, FIG. 3B, FIG. 3C, and FIG. 3D with Nafion™ (Sigma-Aldrich, St. Louis, MO) as the cation-permselective membrane (sometimes noted as a cation-exchange membrane or “CEM”) and Sustainion® (Dioxide Materials, Boca Raton, FL) as the anion-permselective membrane (sometimes noted as an anion-exchange membrane or “AEM”). In this Example, the device was prepared with notched auxiliary channel walls to provide first points of contact for the reaction of desalted ions to form the BaSO₄ precipitate as shown in Equation (2). The cathodic and anodic auxiliary microchannels were filled with a BaCl₂ solution and the droplet was filled with a Na₂SO₄ solution.

Na₂SO₄+BaCl₂→2NaCl+BaSO₄ (2)

FIG. 11A and FIG. 11B show brightfield micrographs taken before and after the application of a voltage bias in the desalting mode. The notched auxiliary microchannel walls provided points of contact for the reaction of the desalted ions, and mass transport was restricted across opposing notches. The ions exited the droplet and reacted with the ions at a distinct wall notch to form an insoluble salt. In FIG. 10B, the red boxes indicate specific notches where precipitation occurred, and the blue box indicates a notch where there is no precipitation.

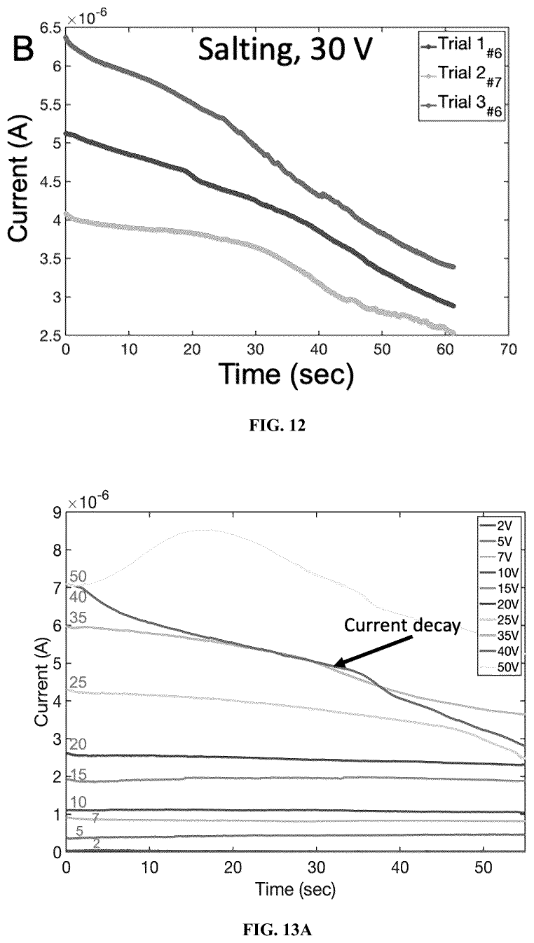

FIG. 12 shows the current transients obtained for salting a stationary set of 6 to 7 droplets under an applied voltage of 30V. The current was observed to decrease over time owing to the formation of ion depletion zones in the auxiliary channels.

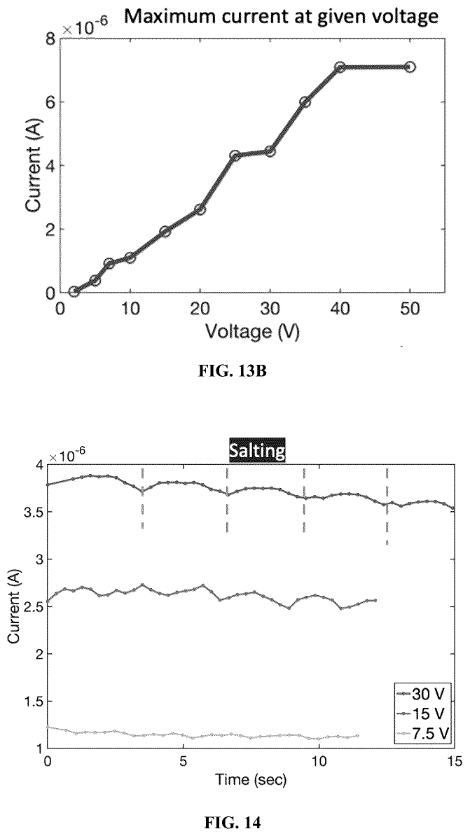

FIG. 13A shows the current transients obtained under distinct applied voltages for salting. The current was observed to decay over time upon the formation of ion depletion zones in the auxiliary channels.

FIG. 13B shows the maximum current obtained under distinct applied voltages. It was found that the maximum current was linearly proportional to the applied voltage magnitude.

FIG. 14 shows the current transients obtained for continuously flowing droplets under three distinct applied voltages (30V, 15V, and 7.5V) for salting. It was observed that the current transients were periodic with more dramatic current shifts observed for 30V compared to 15V and the least dramatic periodic current shifts at 7.5V.

### Example 4: Charged Encapsulated Beads

A device was prepared according to the process illustrated by FIG. 3A, FIG. 3B, FIG. 3C, and FIG. 3D with Nafion™ (Sigma-Aldrich, St. Louis, MO) as the cation-permselective membrane and Sustainion® (Dioxide Materials, Boca Raton, FL) as the anion-permselective membrane. In this Example, the droplet comprised 2 μm polystyrene carboxylate negatively charged beads.

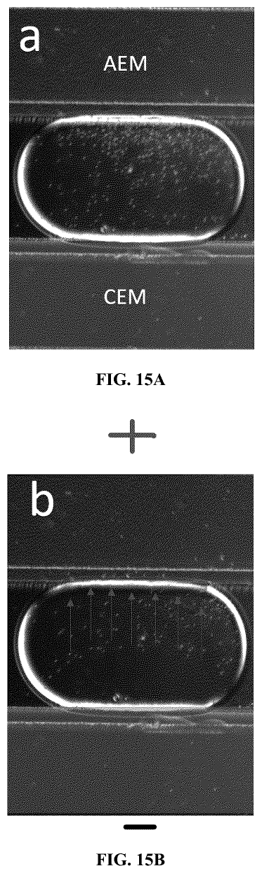

FIG. 15A, FIG. 15B, FIG. 15C, and FIG. 15D show images taken before (FIG. 15A) and during (FIG. 15B, FIG. 15C, and FIG. 15D) the application of a voltage bias in the desalting mode. As shown as bright spots in FIG. 15A, the encapsulated beads were distributed throughout the droplet in the absence of a voltage bias. As illustrated by FIG. 15B, FIG. 15C, and FIG. 15D, over time under a voltage bias, the beads migrate toward the anion-permselective membrane (AEM) as indicated by the arrows in FIG. 15B, but do not exit the droplet due to the large size of the bead. As shown in FIG. 15D, given enough time, the beads adhered to the AEM, unable to escape the droplet.

### Example 5: Charged Large Biomolecules

A device was prepared according to the process illustrated by FIG. 3A, FIG. 3B, FIG. 3C, and FIG. 3D with Nafion™ (Sigma-Aldrich, St. Louis, MO) as the cation-permselective membrane and Sustainion® (Dioxide Materials, Boca Raton, FL) as the anion-permselective membrane. In this Example, the droplet comprised 1 μM AlexaFluor488 dye-linked Rabbit IgG.

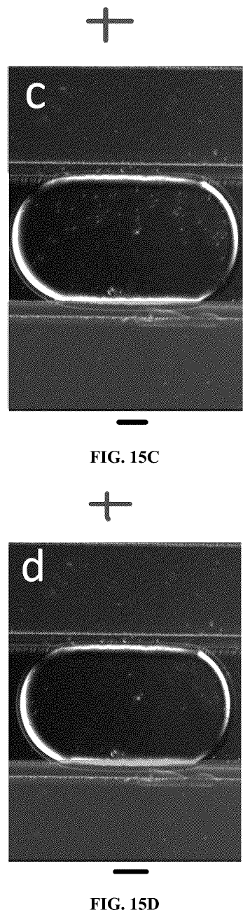

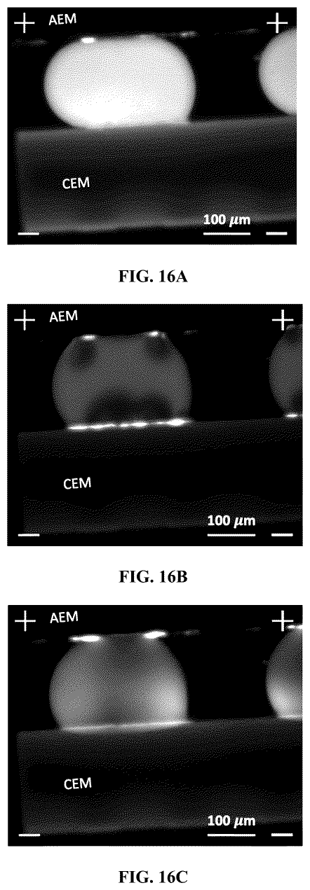

FIG. 16A, FIG. 16B, and FIG. 16C show images taken before (FIG. 16A), during (FIG. 16B), and after (FIG. 16C) the application of a voltage bias of 40V in the desalting mode. As shown in FIG. 16A, the dye-liked Rabbit IgG was distributed uniformly over the droplet in the absence of an electric field. FIG. 16B shows the distribution of dye-linked Rabbit-IgG during the application of 40V for desalting. Ion depletion zones were observed on either droplet hemispheres. Non-specific adsorption of the model biomolecule was observed on the AEM and the CEM. FIG. 16C shows the distribution of dye-linked Rabbit IgG after the voltage is switched off. The non-specific adsorption on the CEM appeared to have lowered (lower fluorescence intensity) with the dye-linked Rabbit IgG redistributed over the entire droplet. Non-specific adsorption over the AEM appeared to have increased (increased fluorescence intensity) after desalting.

### Example 6: Structured Permselective Membranes and/or Electrodes

A device was prepared according to the process illustrated by FIG. 3A, FIG. 3B, FIG. 3C, and FIG. 3D using Nafion™ (Sigma-Aldrich, St. Louis, MO) as the cation-permselective membrane on both sides of the main channel contacting the droplets. In this Example, the device was prepared with a notched membrane pattern to facilitate the formation of regular and/or uniform vortices with ion depletion, and confined enrichment zones. This device is shown in FIG. 17 wherein the blue dotted line shows a part of the patterned membrane. The purple dotted line in the first droplet indicates the location of ion enrichment zone (“IEZ”) generation and confinement, and the black dotted line indicates the location of ion depletion zone (“IDZ) confinement.

FIGS. 18A and 18B show images of droplets containing fluorescent tracer dye bound by notched membranes. No voltage was applied in FIG. 18A and the subtle droplet deformation on either end corresponds to the notches in the membranes. FIG. 18B shows the droplets after applied voltage. As indicated in FIG. 18B, the IEZs and IDZs were confined around the step edges of the membrane. Geometrical confinement of enrichment and depletion zones within a droplet is confirmed, which may result in analyte sensitivity. Additionally, the membrane shape can be modified to control the in-droplet electric field strength, as well as the number and location of IDZs and IEZs.

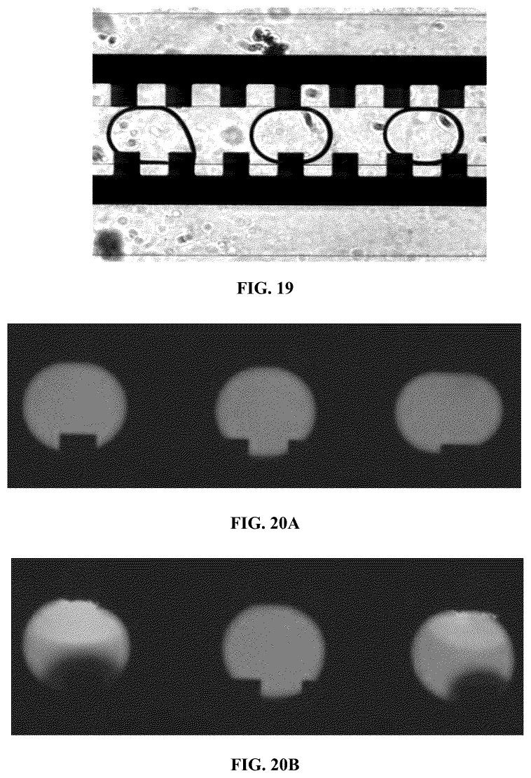

Additionally, a device was prepared as in the above paragraph except the notched membranes were replaced by notched electrodes. A brightfield image of droplets within a main microchannel flanked by notched electrodes is shown in FIG. 19. FIGS. 20A and 20B show images of droplets containing fluorescent tracer dye bound by notched electrodes. No voltage was applied in FIG. 19A, while FIG. 19B shows the droplets after applied voltage. Redox reactions at the electrode edges regulated and defined IDZ and IEZ shape and propagation.

The present disclosure is further defined by the following numbered embodiments.

1. A microfluidic device comprising: at least one fluidic main microchannel, wherein the one or more fluidic main microchannel is connected to at least one inlet and at least one outlet, wherein at least one water-in-oil droplet is infused through the at least one of the inlet(s), flows through at least a portion of the at least one main microchannel, and is withdrawn from at least one of the outlet(s); at least one cation-permselective membrane and at least one anion-permselective membrane, wherein a portion of each membrane extends into the main microchannel along a portion of the length of the main microchannel and a portion of each membrane extends outside of the main microchannel for electrical connection; and at least two auxiliary channels wherein a portion of the permselective membrane that extends outside of the main microchannel extends into a portion of an auxiliary channel wherein the auxiliary channel comprises an electrolyte solution, and wherein the cation-permselective membrane and anion-permselective membranes that extend into the same main microchannel do not extend into the same auxiliary channel, wherein the droplet is in simultaneous contact with a portion of the cation-permselective membrane and the anion-permselective membrane as the droplet flows through and/or is stationary in the main microchannel, and wherein a voltage bias is applied across the permselective membranes for droplet salting and/or desalting.

2. The device according to embodiment 1, wherein the cationic-permselective membrane and the anionic-permselective membrane contact the droplet at opposing sides of the droplet.

3. The device according to any one of embodiments 1 to 2, wherein the walls of at least one of the auxiliary channels comprises notches.

4. The device of any one of embodiments 1 to 3, wherein the permselective membranes extend into the main microchannel for about the entire length of the main microchannel.

5. The device of any one of embodiments 1 to 3, wherein the permselective membranes extend into the main microchannel for at least about half the length of the main microchannel.

6. The device of any one of embodiments 1 to 3, wherein the permselective membranes extend into the main microchannel for at least about 5% of the length of the main microchannel.

7. The device according to any one of embodiments 1 to 6, wherein one cation-permselective membrane and one anion-selective membrane extend into the main microchannel.

8. The device of any one of embodiments 1 to 6, wherein more than one cation-permselective membrane and more than one anion-permselective membrane extend into a main microchannel.

9. The device of any one of embodiments 1 to 8, wherein the auxiliary channels further comprise driving electrodes to apply the voltage bias across the permselective membranes.

10. The device of any one of embodiments 1 to 9, wherein the device comprises more than one main microchannel in fluid connection with a singular inlet.

11. The device of any one of embodiments 1 to 9, wherein the device comprises more than one main microchannel in fluid connection with more than one inlet.

12. The device of any one of embodiments 1 to 11, wherein the device comprises more than one main microchannel in fluid connection with a singular outlet.

13. The device of any one of embodiments 1 to 11, wherein the device comprises more than one main microchannel in fluid connection with more than one outlet.

14. The device of any one of embodiments 1 to 13, wherein the device comprises more than one main microchannel, and wherein at least one permselective membrane extends into a portion of more than one main microchannel.

15. The device of any one of embodiments 1 to 13, wherein the device comprises more than one main microchannel, and wherein the permselective membranes each extend into a unique auxiliary channel.

16. The device of any one of embodiments 1 to 15, wherein the device comprises more than one main microchannel, and wherein at least two permselective membranes (of the same ion selectivity) extend into the same auxiliary channel.

17. The device of any one of embodiments 1 to 16, wherein the permselective membranes have a size and dimension such that the membranes run parallel on either side of the at least one main microchannel and extend into the main microchannel along the length of the main microchannel for a length necessary for salting and/or desalting to occur.

18. The device of any one of embodiments 1 to 17, further comprising uniform flow of the droplets from the at least one inlet to the at least one outlet.

19. The device of embodiment 17, wherein uniform flow is ensured by a pump at an inlet to infuse the droplets into the device.

20. The device of embodiment 17, wherein uniform flow is ensured by a pump at an outlet to withdraw the droplets from the device.

21. The device of embodiment 17, wherein uniform flow is ensured by a syringe attached to tubing at an inlet to infuse the droplets into the device.

22. The device of embodiment 17, wherein uniform flow is ensured by a syringe attached to tubing at an outlet to withdraw the droplets from the device.

23. The device of any one of embodiments 1 to 22, wherein the droplet flow rate is from about 0.0 μm/s to about 5000 μm/s.

24. The device of any one of embodiments 1 to 23, wherein the at least one main microchannel has a length of about 1.0 mm to about 100 mm.

25. The device of any one of embodiments 1 to 24, wherein the at least one main microchannel has a width of about 10 μm to about 1000 μm.

26. The device of any one of embodiments 1 to 25, wherein the main microchannel has a height of about 10 μm to about 1000 μm.

27. The device of any one of embodiments 1 to 26, wherein the walls, ceiling, and/or floor of the main microchannel comprise polydimethylsiloxane (“PDMS”), polymethylmethacrylate (“PMMA”), polystyrene, polycarbonate, cyclic olefin polymer, cyclic olefin copolymer, pressure sensitive adhesive tape, silicon, glass, resin of a 3D printer, polyethylene glycol, crosslinked polyethylene glycol diacrylate (“PEGDA”) resin, or combinations thereof.

28. The device of any one of embodiments 1 to 27, wherein the volume of the droplets is from about 10 pL to about 50.0 nL.

29. The device of any one of embodiments 1 to 28, wherein the droplets comprise proteins, antigens, bioparticles, bacteria, virus, nucleic acids, enzymes, biological cells, DNA, RNA, aptamers, antibodies, peptides, peptide nucleic acids, morpholino oligonucleotides, receptors, other bioparticles, other nano/micro particles, or a combination thereof.

30. The device of any one of embodiments 1 to 29, wherein the droplets comprise blood, blood plasma, saliva, urine, sweat, tears, or any other such biofluid or any combination thereof.

31. The device of any one of embodiments 1 to 30, wherein the droplets comprise an electrolyte solution.

32. The device of any one of embodiments 1 to 31, wherein the droplets comprise phosphate buffer, Tris buffer, and/or combinations thereof.

33. The device of any one of embodiments 1 to 32, wherein the length of the permselective membranes is from about 1.0 mm to about 100 mm.

34. The device of any one of embodiments 1 to 33, wherein the width of the permselective membranes is from about 50 μm to about 1000 μm.

35. The device of any one of embodiments 1 to 34, wherein the thickness of the permselective membranes is from about 1.0 μm to about 50 am.

36. The device of any one of embodiments 1 to 35, wherein the auxiliary microchannels have a length of about 2.0 mm to about 100 mm.

37. The device of any one of embodiments 1 to 36, wherein the auxiliary microchannels have a width of about 10 μm to about 1000 μm.

38. The device of any one of embodiments 1 to 37, wherein the auxiliary microchannels have a height of about 10 μm to about 1000 μm.

39. The device of any one of embodiments 1 to 38, wherein the walls, ceiling, and/or floor of the auxiliary microchannel comprise polydimethylsiloxane (“PDMS”), polymethylmethacrylate (“PMMA”), polystyrene, polycarbonate, cyclic olefin polymer, cyclic olefin copolymer, pressure sensitive adhesive tape, silicon, glass, resin of a 3D printer, polyethylene glycol, crosslinked polyethylene glycol diacrylate (“PEGDA”) resin, or combinations thereof.

40. The device of any one of embodiments 1 to 39, wherein the electrolyte solution within the auxiliary channels comprises NaCl, KCl, Na₂SO₄, HCl, H₂SO₄, NaOH, KOH, NaNO₃, KNO₃, phosphate buffer, carbonate buffer, acetate buffer, borate buffer, Tris buffer, HEPES (4-(2-hydroxyethyl)-1-piperazineethanesulfonic acid), MOPS (3-(N-morpholino) propanesulfonic acid), TAE (Tris-acetate-EDTA), PIPES (piperazine-N,N′-bis(2-ethanesulfonic acid), tricine buffer, PBS (phosphate buffered saline) and/or combinations thereof.

41. The device of any one of embodiments 1 to 40, wherein the outlet is connected to a droplet splitting device.

42. The device of any one of embodiments 1 to 41, wherein the outlet collects the droplets for further analysis and/or for further processing.

43. The device of any one of embodiments 1 to 42, wherein the voltage applied to the permselective membranes is between about 0V and about 500V.

44. The device of any one of embodiments 1 to 43, wherein at least a portion the edge of at least one permselective membrane comprises notches.

45. The device of any one of embodiments 1 to 44, wherein at least a portion of the edge of at least one permselective membrane is structured as notches, spikes, or a combination of any shape thereof.

46. The device of any one of embodiments 1 to 45, wherein at least a portion of a permselective membrane is replaced with electrode material.

47. The device of embodiment 46 wherein the electrode material comprises gold.

48. A method for extracting ions out of a droplet comprising: flowing at least one water-in-oil droplet through at least one main microchannel of the microfluidic device of any one of embodiments 1 to 47; and applying a voltage bias across the device, wherein the auxiliary channel the cation-permselective membrane extends into is cathodic, wherein the auxiliary channel the anion-permselective membrane extends into is anodic, and extracting at least one ion out of the droplet.

49. The method of embodiment 48, wherein at least one cation within the droplet is extracted out of the droplet, across the cation-permselective membrane, and into the auxiliary channel.

50. The method of any one of embodiments 48 and 49, wherein at least one anion within the droplet is extracted out of the droplet, across the anion-selective membrane, and into the auxiliary channel.

51. The method of any one of embodiments 48 to 50, wherein the ions in the droplet are reduced by about 10%, about 20%, about 30%, about 40%, about 50%, about 60%, about 70%, about 80%, about 90%, or about 100%.

52. The method of any one of embodiments 48 to 51, wherein the pore size of the cation-permselective membrane and/or the pore size of the anion-selective membrane is such that large analytes are not extracted from the droplet.

53. A method for introducing ions into a droplet comprising: flowing at least one water-in-oil droplet through at least one main microchannel of the microfluidic device of any one of embodiments 1 to 47; and applying a voltage bias across the device, wherein the auxiliary channel the cation-permselective membrane extends into is anodic, wherein the auxiliary channel the anion-permselective membrane extends into is cathodic, and introducing at least one ion into the droplet.

54. The method of embodiment 53, wherein at least one cation is extracted from the auxiliary channel, across the cation-permselective membrane, and into the droplet.

55. The method of any one of embodiments 53 to 54, wherein at least one anion is extracted from the auxiliary channel, across the anion-permselective membrane, and into the droplet.

56. The method of any one of embodiments 53 to 55, wherein the ions in the droplet are increased by about 10%, about 20%, about 30%, about 40%, about 50%, about 60%, about 70%, about 80%, about 90%, or about 100%.

57. A method of introducing ions into a droplet and/or extracting ions from a droplet comprising: flowing at least one water-in-oil droplet through at least one main microchannel of any one of claims 1 to 47; applying a voltage bias across the device for a period of time such that the auxiliary channel the cation-permselective membrane extends into is cathodic and the auxiliary channel the anion-permselective membrane extends into is anodic to extract at least one ion from the droplet; and/or applying a voltage bias across the device for a period of time such that the auxiliary channel the cation-permselective membrane extends into is anodic and the auxiliary channel the anion-permselective membrane extends into is cathodic to introduce at least one ion into the droplet.

58. The method of embodiment 57, wherein method comprises applying the voltage bias to extract at least one ion from the droplet, and thereafter reversing the voltage bias to introduce at least one ion into the droplet as the droplet flows through the main microchannel.

59. The method of embodiment 57, wherein the method comprises applying voltage bias to introduce at least one ion into the droplet, and thereafter reversing the voltage bias to extract at least one ion from the droplet as the droplet flows through the main microchannel.

60. The method of any one of embodiments 58 to 59, wherein the method comprises reversing the voltage bias at least one time to alternate introducing ions into the droplet and extracting ions from the droplet as the droplet flows through the main microchannel.

61. The method of any one of embodiments 58 to 60, wherein the method comprises reversing the voltage bias from one to 100 times as the droplet flows through the main microchannel.

62. The method of any one of embodiments 57 to 61, wherein the pore size of the cation-permselective membrane and/or the pore size of the anion-selective membrane is such that large microparticles are not extracted from the droplet.

63. The method of embodiment 62, wherein the large microparticles comprise proteins.

64. A microfluidic device comprising: at least one fluidic main microchannel, wherein the one or more fluidic main microchannel is connected to at least one inlet and at least one outlet, wherein at least one water-in-oil droplet is infused through the at least one of the inlet(s), flows through the at least one main microchannel, and is withdrawn from at least one of the outlet(s); at least two permselective membranes comprising notches, wherein a portion of each membrane extends into the main microchannel along a portion of the length of the main microchannel and a portion of each membrane extends outside of the main microchannel for electrical connection; and at least two auxiliary channels wherein a portion of the permselective membrane that extends outside of the main microchannel extends into a portion of an auxiliary channel wherein the auxiliary channel comprises an electrolyte solution, and wherein the at least two permselective membranes that extend into the same main microchannel do not extend into the same auxiliary channel, wherein the droplet is in simultaneous contact with both permselective membranes as the droplet flows through and/or is stationary in the main microchannel, and wherein a voltage bias is applied across the permselective membranes for monodirectional or unified salting and/or desalting.

65. The device of embodiment 64, wherein the at least two permselective membranes comprise cation-permselective membranes.

66. The device of embodiment 64, wherein the at least two permselective membranes comprise anion-selective membranes.

67. A microfluidic device comprising: at least one fluidic main microchannel, wherein the one or more fluidic main microchannel is connected to at least one inlet and at least one outlet, wherein at least one water-in-oil droplet is infused through the at least one of the inlet(s), flows through the at least one main microchannel, and is withdrawn from at least one of the outlet(s); at least two electrodes comprising notches, wherein a portion of each electrode extends into the main microchannel along a portion of the length of the main microchannel and a portion of each electrode extends outside of the main microchannel for electrical connection; and at least two auxiliary channels wherein a portion of the electrode that extends outside of the main microchannel extends into a portion of an auxiliary channel wherein the auxiliary channel comprises an electrolyte solution, and wherein the at least two electrodes that extend into the same main microchannel do not extend into the same auxiliary channel, wherein the droplet is in simultaneous contact with both electrodes as the droplet flows through and/or is stationary in the main microchannel, and wherein a voltage bias is applied across the electrodes for geometrical confinement of at least one ion enrichment zone and/or at least one ion depletion zone within the droplet.

68. A method of introducing ions into a droplet and/or extracting ions from a droplet comprising: flowing at least one water-in-oil droplet through at least one main microchannel of any one of embodiments 64 to 66; applying a voltage bias across the device for a period of time to extract at least one ion from the droplet and introduce at least one ion into the droplet.

69. The method of embodiment 68, wherein the extraction and introduction of ions is monodirectional.

70. The method of any one of embodiments 68 to 69, wherein the notches provide defined sites for introducing and extracting the ions.

71. A method of geometrical confinement of at least one ion enrichment zone and/or at least one ion depletion zone within a droplet comprising: flowing at least one water-in-oil droplet through at least one main microchannel of any one of embodiments 64 to 67; and applying a voltage bias across the device for a period of time to geometrically confine at least one ion enrichment zone and/or at least one ion depletion zone within the droplet.

72. The method of embodiment 71, wherein the notches provide higher surface area for electromechanical reactions inside the droplet.

73. The method of any one of embodiments 71 to 72, wherein redox reactions at the electrode edges regulate and/or define ion depletion zone and ion enrichment zone shape and propagation

While this invention may be embodied in many different forms, the described scientific papers and other referenced materials mentioned herein are incorporated by reference in their entirety. Furthermore, the invention encompasses any possible combination of some or all of the various embodiments mentioned herein, described herein and/or incorporated herein. In addition, the invention encompasses any possible combination that also specifically excludes any one or some of the various embodiments mentioned herein, described herein and/or incorporated herein.

The above disclosure is intended to be illustrative and not exhaustive. This description will suggest many variations and alternatives to one of ordinary skill in this art. All these alternatives and variations are intended to be included within the scope of the following claims where the term “comprising” means “including, but not limited to”. Those familiar with the art may recognize other equivalents to the specific embodiments described herein which equivalents are also intended to be encompassed by the following claims

What is claimed is:

1. A microfluidic device comprising:
at least one fluidic main microchannel, wherein the one or more fluidic main microchannel is connected to at least one inlet and at least one outlet, wherein at least one water-in-oil droplet is infused through the at least one of the inlet(s), flows through the at least one main microchannel, and is withdrawn from at least one of the outlet(s);
at least one cation-permselective membrane and at least one anion-permselective membrane, wherein a portion of each membrane extends into the main microchannel along a portion of the length of the main microchannel and a portion of each membrane extends outside of the main microchannel for electrical connection; and
at least two auxiliary channels wherein a portion of the permselective membrane that extends outside of the main microchannel extends into a portion of an auxiliary channel wherein the auxiliary channel comprises an electrolyte solution, and wherein the cation-permselective membrane and anion-permselective membranes that extend into the same main microchannel do not extend into the same auxiliary channel,
wherein the droplet is in simultaneous contact with a portion of the cation-permselective membrane and a portion of the anion-permselective membrane as the droplet flows through a portion of the main microchannel and/or is stationary in the main microchannel, and
wherein a voltage bias is applied across the permselective membranes for droplet salting and/or desalting.

2. The device according to claim 1, wherein the cationic-permselective membrane and the anionic-permselective membrane contact the droplet at opposing sides of the droplet.

3. The device according to claim 1, wherein the walls of at least one of the auxiliary channels comprises notches.

4. The device of claim 1, wherein the volume of the droplet is from about 10 pL to about 50.0 nL.

5. The device of claim 1, wherein the outlet is connected to a droplet splitting device.

6. The device of claim 1, wherein the outlet collects the droplet for further analysis and/or for further processing.

7. The device of claim 1, wherein at least a portion of the edge of at least one permselective membrane comprises notches.

8. The device of claim 1, wherein at least a portion of at least one permselective membrane is replaced with electrode material.

9. A method for extracting ions out of a droplet comprising:
flowing at least one water-in-oil droplet through at least a portion of one main microchannel of the microfluidic device of claim 1; and
applying a voltage bias across the device,
wherein the auxiliary channel the cation-permselective membrane extends into is cathodic,
wherein the auxiliary channel the anion-permselective membrane extends into is anodic, and
extracting at least one ion out of the droplet.

10. The method of claim 9, wherein at least one cation within the droplet is extracted out of the droplet, across the cation-permselective membrane, and into the auxiliary channel.

11. The method of claim 9, wherein at least one anion within the droplet is extracted out of the droplet, across the anion-selective membrane, and into the auxiliary channel.

12. The method of claim 9, wherein the ions in the droplet are reduced by about 10%, about 20%, about 30%, about 40%, about 50%, about 60%, about 70%, about 80%, about 90%, or about 100%.

13. The method of claim 9, wherein the droplets comprise proteins, antigens, bioparticles, bacteria, virus, nucleic acids, enzymes, biological cells, DNA, RNA, aptamers, antibodies, peptides, peptide nucleic acids, morpholino oligonucleotides, receptors, other bioparticles, other nano/micro particles, blood, blood plasma, saliva, urine, sweat, tears, or any other such biofluid, or a combination thereof.

14. The method of claim 9, wherein the pore size of the cation-permselective membrane and/or the pore size of the anion-selective membrane is such that large analytes are not extracted from the droplet.

15. A method for introducing ions into a droplet comprising:
flowing at least one water-in-oil droplet through at least a portion of one main microchannel of the microfluidic device of claim 1; and
applying a voltage bias across the device,
wherein the auxiliary channel the cation-permselective membrane extends into is anodic,
wherein the auxiliary channel the anion-permselective membrane extends into is cathodic, and
introducing at least one ion into the droplet.

16. The method of claim 15, wherein at least one cation is extracted from the auxiliary channel, across the cation-permselective membrane, and into the droplet.

17. The method of claim 15, wherein at least one anion is extracted from the auxiliary channel, across the anion-permselective membrane, and into the droplet.

18. The method of claim 15, wherein the ions in the droplet are increased to a concentration of up to about equal to the concentration of ions in the electrolyte solution or wherein the ions in the droplet are increased to a concentration of from about equal to the concentration of ions in the electrolyte solution to up to about ten times the concentration of ions in the electrolyte solution.

19. The method of claim 15, wherein the droplets comprise proteins, antigens, bioparticles, bacteria, virus, nucleic acids, enzymes, biological cells, DNA, RNA, aptamers, antibodies, peptides, peptide nucleic acids, morpholino oligonucleotides, receptors, other bioparticles, other nano/micro particles, blood, blood plasma, saliva, urine, sweat, tears, or any other such biofluid, or a combination thereof.

20. A method of introducing ions into a droplet and extracting ions from a droplet comprising:
flowing at least one water-in-oil droplet through at least a portion of one main microchannel of the microfluidic device according to claim 1;
applying a voltage bias across the device for a period of time such that the auxiliary channel the cation-permselective membrane extends into is cathodic and the auxiliary channel the anion-permselective membrane extends into is anodic to extract at least one ion from the droplet; or
applying a voltage bias across the device for a period of time such that the auxiliary channel the cation-permselective membrane extends into is anodic and the auxiliary channel the anion-permselective membrane extends into is cathodic to introduce at least one ion into the droplet; or
reversing the voltage bias at least one time to alternate introducing ions into the droplet and extracting ions from the droplet as the droplet flows through the main microchannel.
